(19) United States
(12) Patent Application Publication
(10) Pub. No.: US 2022/0212473 A1
(43) Pub. Date: Jul. 7, 2022

(54) PRINTER AND CLEANING ASSEMBLY

(71) Applicant: BROTHER KOGYO KABUSHIKI KAISHA, Nagoya (JP)

(72) Inventors: Kakeru HAYASHI, Nagoya (JP); Noriyuki KAWAMATA, Nagoya (JP); Yoshinori KATO, Nagoya (JP); Katsunori NISHIDA, Nagoya (JP)

(21) Appl. No.: 17/705,581

(22) Filed: Mar. 28, 2022

Related U.S. Application Data
(63) Continuation of application No. PCT/JP2021/008673, filed on Mar. 5, 2021.

(30) Foreign Application Priority Data
Mar. 10, 2020 (JP) 2020-040492

(51) Int. Cl. B41J 2/165

(52) U.S. Cl. CPC B41J 2/1652; B41J 2/16535

(57) ABSTRACT

A printer includes: a discharge portion discharging ink; a cleaning fluid vessel including an inflow port, and a first peripheral wall and a first bottom wall extending in a first direction orthogonal to an up-down direction, or in a second direction orthogonal to the up-down direction and the first direction and defining a storage space for storing a cleaning fluid flowing in from the inflow port; a flushing box, connected to the cleaning fluid vessel in one of the first direction, for receiving the ink discharged from the discharge portion; and a first communicating portion causing the cleaning fluid vessel and the flushing box to be communicated.

### CROSS-REFERENCE TO RELATED APPLICATIONS

This application is a continuation application of International Patent Application No. PCT/JP2021/008673 filed Mar. 5, 2021, which claims priority from Japanese Patent Application No. 2020-040492 filed Mar. 10, 2020. The contents of the foregoing application are hereby incorporated herein by reference.

### BACKGROUND

The present disclosure relates to a printer and a cleaning assembly that cleans an ink discharge portion in the printer.

A known inkjet printer includes a wiper that wipes inkjet nozzles, and a cleaning vessel in which a cleaning fluid that cleans the wiper is stored. A first tube is connected to the cleaning vessel via an opening. When the cleaning fluid is stored in the cleaning vessel up to the height of the opening, the cleaning fluid is caused to flow out to a waste liquid receiving member through the first tube. The cleaning fluid that has flowed out to the waste liquid receiving member is stored in a waste liquid bottle after passing through a second tube. The inkjet printer supplies the cleaning fluid to the cleaning vessel and causes the cleaning fluid to flow out from the cleaning vessel to the waste liquid receiving member via the first tube.

### SUMMARY

In a printer, a container (a flushing box) is provided that receives ink discharged from a discharge portion, as a result of a flushing operation. The ink discharged to the flushing box is not cleaned by a cleaning fluid and there is thus a possibility that some of the ink may accumulate inside the flushing box, and may become more viscous or solidify. If the ink inside the flushing box becomes more viscous or solidifies, there is a possibility that a discharge port provided in the flushing box may become clogged, and it may not be possible to discharge the ink from the flushing box.

Various exemplary embodiments of the general principles described herein provide a printer capable of assisting, using a cleaning fluid, the discharge of a waste liquid, such as ink, that has accumulated in a flushing box, and a cleaning assembly that cleans an ink discharge portion in the printer.

A printer according to a first aspect of the present disclosure includes: a discharge portion configured to discharge ink; a cleaning fluid vessel including an inflow port, and a first peripheral wall and a first bottom wall defining a storage space configured to store cleaning fluid inflowing from the inflow port and extending in a first direction orthogonal to an up-down direction, or in a second direction orthogonal to the up-down direction and the first direction; a flushing box, connected to the cleaning fluid vessel on one side in the first direction, configured to receive the ink discharged from the discharge portion; and a first communicating portion configured to communicate the cleaning fluid vessel and the flushing box.

A cleaning assembly according to a second aspect of the present disclosure includes: a cleaning fluid vessel including an inflow port, and a first peripheral wall and a first bottom wall defining a storage space configured to store cleaning fluid inflowing from the inflow port and extending in a first direction orthogonal to an up-down direction, or in a second direction orthogonal to the up-down direction and the first direction; a flushing box, connected to the cleaning fluid vessel on one side in the first direction, configured to receive an ink discharged from a discharge portion configured to discharge the ink; and a first communicating portion configured to communicate the cleaning fluid vessel and the flushing box.

According to the first aspect and the second aspect, the cleaning fluid that has flowed into the cleaning fluid vessel from the inflow port flows into the flushing box via the first communicating portion. Using the cleaning fluid that has flowed in from the cleaning fluid vessel, the printer can assist the discharge of waste liquid, such as the ink that has accumulated in the flushing box. As a result, the printer can reduce a possibility of the waste liquid that has accumulated in the flushing box from becoming more viscous and solidifying, and can reduce a possibility of not being discharge the waste liquid from the flushing box.

### BRIEF DESCRIPTION OF THE DRAWINGS

Embodiments will be described below in detail with reference to the accompanying drawings in which:

FIG. 1 is a perspective view of a printer;

FIG. 2 is a perspective view illustrating an interior structure of the printer;

FIG. 3 is a plan view illustrating the internal structure of the printer;

FIG. 4 is a perspective view of a cleaning assembly;

FIG. 5 is a plan view of the cleaning assembly;

FIG. 6 is a left side view of the cleaning assembly;

FIG. 7 is a cross-sectional view as seen in the direction of arrows along a line A-A illustrated in FIG. 5, when a first wiper and a second wiper are in non-contact positions;

FIG. 8 is cross-sectional view as seen in the direction of arrows along a line B-B illustrated in FIG. 5;

FIG. 9 is a cross-sectional view as seen in the direction of arrows along a line C-C illustrated in FIG. 5, when the first wiper and the second wiper are in an intermediate position;

FIG. 10 is a block diagram illustrating an electrical configuration of the printer;

FIG. 11 is a flowchart of periodic processing;

FIG. 12 is a flowchart of main processing;

FIG. 13 is a flowchart of the main processing and is a continuation of FIG. 12;

FIG. 14 is a diagram illustrating a positional relationship between the cleaning assembly and a carriage when the carriage is at a reference position;

FIG. 15 is a diagram illustrating a positional relationship between the cleaning assembly and the carriage when the carriage is at a first wiping position;

FIG. 16 is a diagram illustrating a positional relationship between the cleaning assembly and the carriage when a first head is being wiped;

FIG. 17 is a diagram illustrating a positional relationship between the cleaning assembly and the carriage that is at a first flushing position;

FIG. 18 is a diagram illustrating a positional relationship between the cleaning assembly and the carriage when a second head is being wiped;

FIG. 19 is a diagram illustrating a positional relationship between the cleaning assembly and the carriage that is at a second flushing position; and

FIG. 20 is a diagram illustrating a positional relationship between the cleaning assembly and the carriage when the main processing ends.

### DETAILED DESCRIPTION

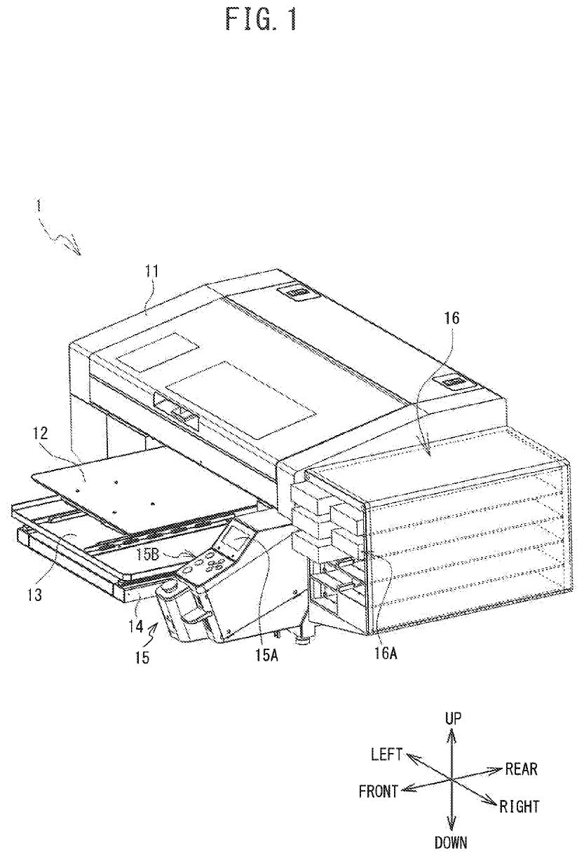

A printer 1 according to an embodiment of the present disclosure will be described. The directions of up, down, lower left, upper right, lower right, and upper left in FIG. 1 correspond to an upper side, a lower side, front, rear, right, and left, respectively, of the printer 1. Note that mechanical elements of the present embodiment represented in the drawings indicate an actual scale.

Overview of Printer 1

The printer 1 is an inkjet printer that discharges a liquid and performs printing on a print medium, which is a cloth such as a T-shirt, paper, or the like. The printer 1 prints a color image on the print medium, for example, by discharging, downward, five different types of ink (white, black, yellow, cyan, and magenta), which are the liquid. In the following description, of the five types of ink, the white-colored ink is referred to as “white ink,” and when no particular distinction is made between the four colors of black, cyan, yellow, and magenta ink, they are collectively referred to as “color inks.”

As illustrated in FIG. 1, the printer 1 is provided with a housing 11, a platen 12, a tray 13, a platen drive mechanism 14, an operation portion 15, a mounting portion 16, and the like. The housing 11 is a cuboid shape and the front surface and the rear surface thereof respectively include openings. The operation portion 15 is provided at a position to the right and to the front of the housing 11. The operation portion 15 is provided with a display 15A and operation buttons 15B. The display 15A is a liquid crystal display (LCD) that can display various information. The operation buttons 15B are operated when a user inputs commands relating to various operations of the printer 1.

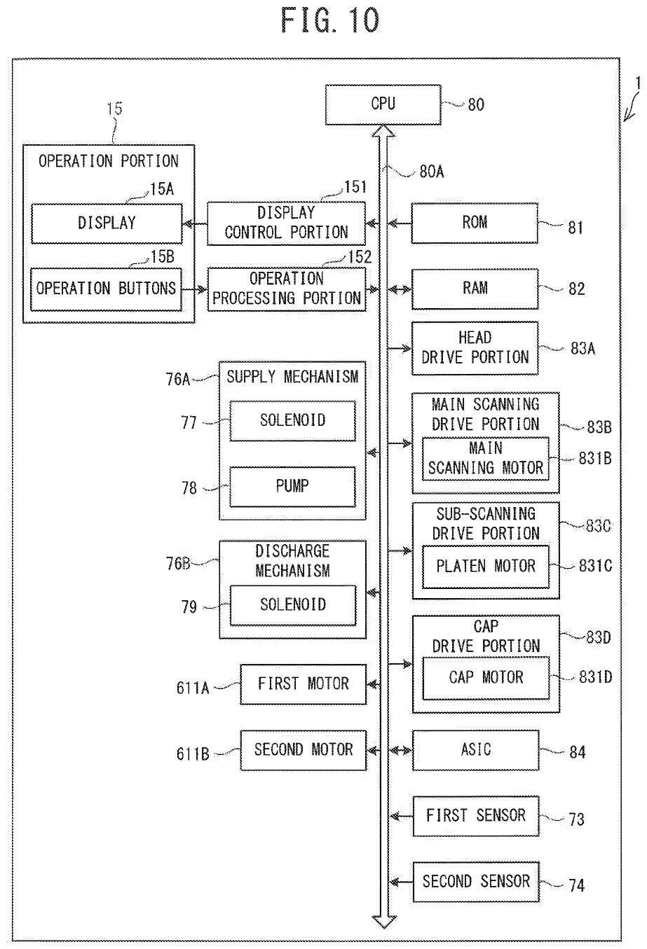

A sub-scanning drive portion 83C (refer to FIG. 10) that moves the platen 12 and the tray 13 using driving of a platen motor 831C (refer to FIG. 10) is built into the platen drive mechanism 14. The platen 12 is a plate shape that is rectangular in a plan view. The print medium is placed on the upper surface of the platen 12. The tray 13 that protects the print medium is rectangular in a plan view, and is provided below the platen 12. The mounting portion 16 is provided at the right of the housing 11. Cartridges 16A are connected to the mounting portion 16. A liquid stored in the cartridges 16A is supplied to heads.

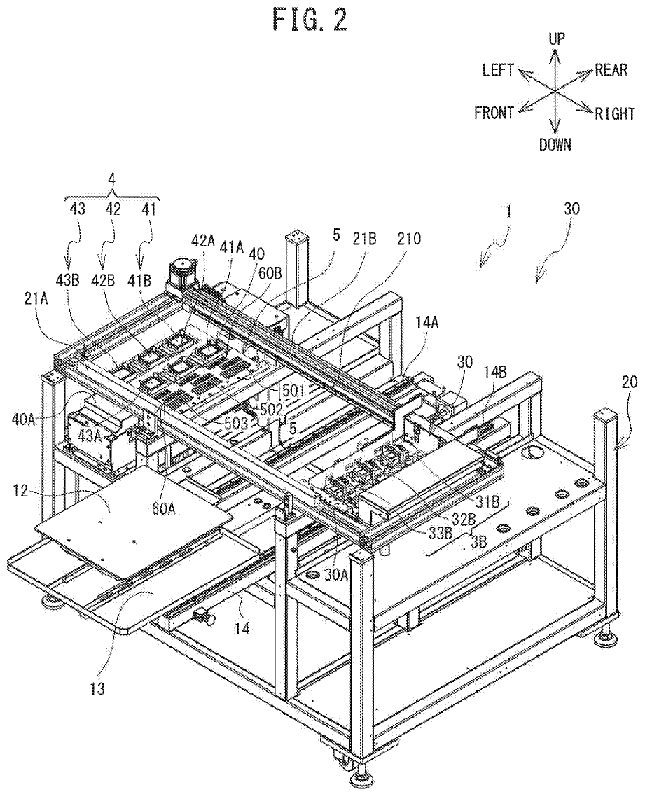

As illustrated in FIG. 2, a frame body 20, guide shafts 21A and 21B, a carriage 30, a cap mechanism 40, and cleaning assemblies 501, 502, and 503 (hereinafter referred to collectively as a cleaning assembly 5 when no distinction is made therebetween) are provided inside the housing 11 (refer to FIG. 1). The frame body 20 is a lattice-shaped structural body. The guide shafts 21A and 21B are supported on the upper ends of the frame body 20. The frame body 20 supports the platen drive mechanism 14 at the center of the frame body 20 in the left-right direction, and at a position lower than the guide shafts 21A and 21B in the up-down direction.

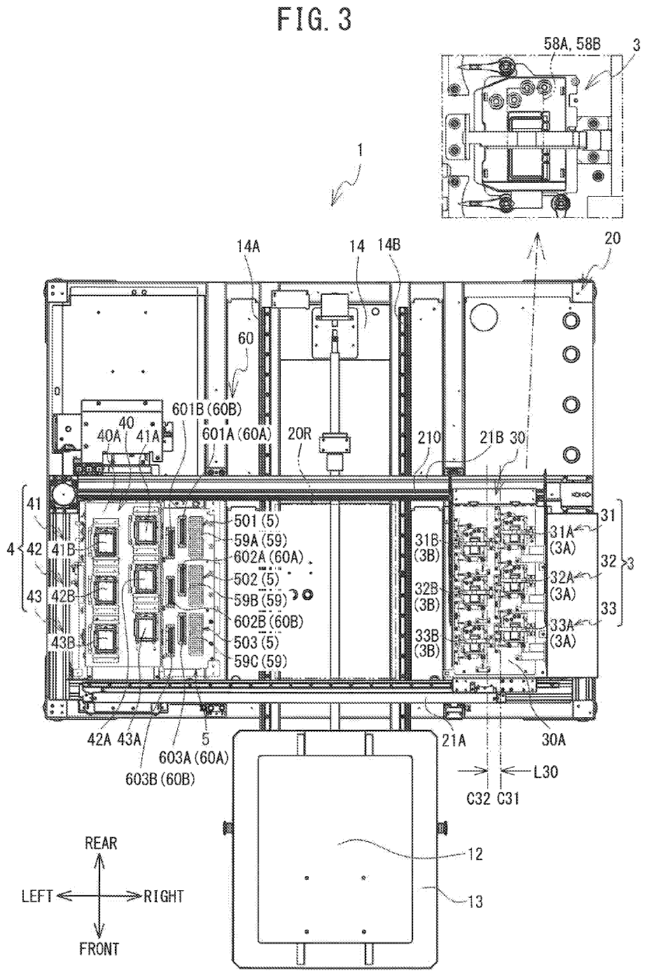

The guide shafts 21A and 21B extend in the left-right direction. The guide shafts 21A and 21B are arranged in parallel to each other with an interval therebetween in the front-rear direction. The guide shafts 21A and 21B support the carriage 30 such that the carriage 30 is movable in the left-right direction (hereinafter also referred to as a main scanning direction). FIG. 2 and FIG. 3 illustrate a state in which the carriage 30 has moved to a right end. The carriage 30 includes heads 31, 32, and 33 (refer to FIG. 3, hereinafter collectively referred to as heads 3 or a head 3 when no distinction is made therebetween) that discharge the ink. The head 3 includes a piezoelectric element. However, the head 3 may include a heater, in place of the piezoelectric element, as a configuration that discharges the ink. A drive belt 210, which is provided along the guide shaft 21B, moves in the main scanning direction due to driving of a main scanning motor 813B (refer to FIG. 10) of a main scanning drive portion 83B (refer to FIG. 10). The carriage 30 is coupled to the drive belt 210, and is moved in the main scanning direction by the drive belt 210. A region sandwiched, from the front and rear directions, between the guide shafts 21A and 21B corresponds to a movement path of the carriage 30.

The platen drive mechanism 14 includes guide rails 14A and 14B at the upper surface thereof. The guide rails 14A and 14B extend in the front-rear direction. The guide rails 14A and 14B are arranged in parallel to each other with an interval therebetween in the left-right direction. The guide rails 14A and 14B support the platen 12 and the tray 13 such that the platen 12 and the tray 13 are movable in the front-rear direction (hereinafter also referred to as a sub-scanning direction). A region positioned between the guide rails 14A and 14B in the left-right direction corresponds to a movement path of the platen 12.

As illustrated in FIG. 3, the movement path of the platen 12, which moves along the guide rails 14A and 14B, intersects, in the front-rear direction, the movement path of the carriage 30, which moves along the guide shafts 21A and 21B, below a central portion, in the main scanning direction, of the movement path of the carriage 30. Hereinafter, a region in which the movement path of the platen 12 intersects the movement path of the carriage 30 in the up-down direction is referred to as a printing region 20R.

As illustrated in FIG. 2, the cap mechanism 40 and the cleaning assembly 5 are provided lower than the movement path of the carriage 30 in the up-down direction, and further to the left than the movement path of the platen 12 in the main scanning direction. The cap mechanism 40 and the cleaning assembly 5 are aligned in the main scanning direction, and the cap mechanism 40 is disposed to the left of the cleaning assembly 5, for example.

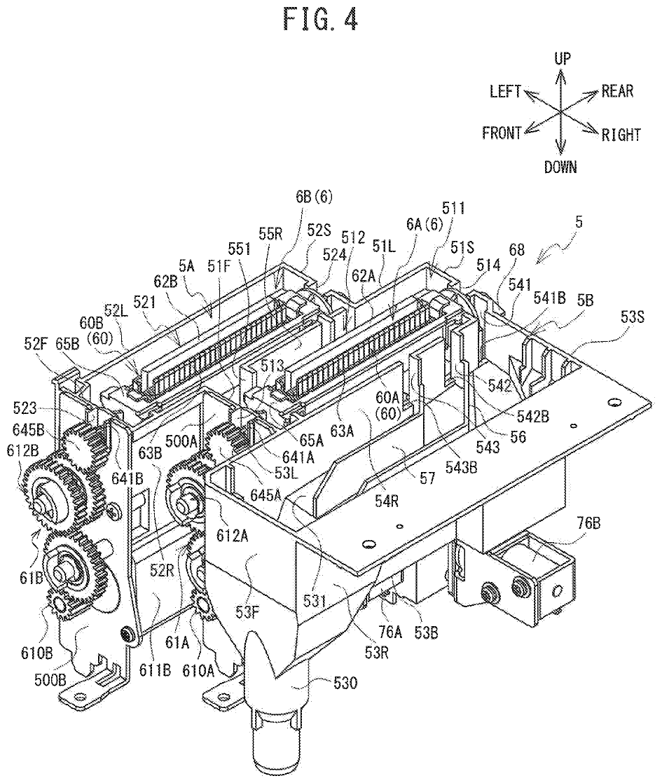

The cap mechanism 40 includes caps 41, 42, and 43 (hereinafter, when no distinction is made between the caps 41 to 43, they are referred to as caps 4). The cleaning assembly 5 includes a cleaning fluid vessel 5A and a flushing box 5B (refer to FIG. 4).

In the printer 1, the carriage 30 reciprocates in the main scanning direction while the platen 12 conveys the print medium in the sub-scanning direction. At this time, the printing is performed on the print medium by discharging the ink from the heads 3 onto the print medium placed on the platen 12 in the printing region 20R.

Carriage 30

As illustrated in FIG. 2 and FIG. 3, the carriage 30 includes a support portion 30A that supports the heads 3. The front end of the support portion 30A is supported by the guide shaft 21A so as to be movable in the main scanning direction. The rear end of the support portion 30A is supported by the guide shaft 21B so as to be movable in the main scanning direction. The drive belt 210 is connected to the rear end of the support portion 30A.

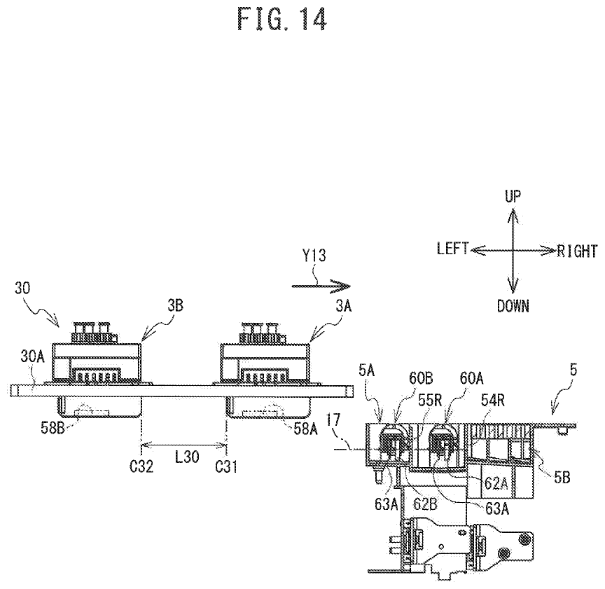

As illustrated in FIG. 3, the heads 31 include a first head 31A and a second head 31B having the same structure as each other. A discharge portion 58A is provided on the bottom surface of the first head 31A (refer to FIG. 14). A discharge portion 58B is provided on the bottom surface of the second head 31B (refer to FIG. 14). The discharge portions 58A and 58B are formed by a plurality of nozzles that discharge the ink being arrayed in the horizontal direction. The white ink is discharged from the discharge portion 58A. The color ink is discharged from the discharge portion 58B. The respective positions of the discharge portions 58A and 58B are aligned in the up-down direction. The first head 31A and the second head 31B are arranged with an interval therebetween in the main scanning direction. The first head 31A is disposed to the right of the second head 31B. A part of the front side of the discharge portion 58A of the first head 31A overlaps, in the sub-scanning direction, with a part of the rear side of the discharge portion 58B of the second head 31B. In other words, in the sub-scanning direction, the front end of the discharge portion 58A of the first head 31A is positioned between the front end and the rear end of the discharge portion 58B of the second head 31B. In the sub-scanning direction, the rear end of the discharge portion 58B of the second head 31B is positioned between the front end and the rear end of the discharge portion 58A of the first head 31A.

The heads 32 include a first head 32A and a second head 32B. The first head 32A is positioned to the front of the first head 31A. The second head 32B is positioned to the front of the second head 31B.

The head 33 includes a first head 33A and a second head 33B. The first head 33A is positioned to the front of the first head 32A. The second head 33B is positioned to the front of the second head 32B. The first heads 31A to 33A and the second heads 31B to 33B have the same structure as each other. The positional relationship of the second head 32B with respect to the first head 32A and the positional relationship of the second head 33B with respect to the first head 33A are the same as the positional relationship of the second head 31B with respect to the first head 31A. Hereinafter, when no distinction is made between the first heads 31A, 32A, and 33A, they are collectively referred to as first heads 3A or the first head 3A. When no distinction is made between the second heads 31B, 32B, and 33B, they are collectively referred to as second heads 3B or the second head 3B.

As illustrated in FIG. 3 and FIG. 14, a position C31 of the left end of the first head 3A and a position C32 of the right end of the second head 3B are separated by an interval L30 in the main scanning direction. Hereinafter, the interval L30 is defined as an interval in the main scanning direction between the first head 3A and the second head 3B.

Cap Mechanism 40

As illustrated in FIG. 2 and FIG. 3, the cap mechanism 40 includes a support portion 40A that supports the caps 4. The support portion 40A can be moved up and down by a cap drive portion 83D (refer to FIG. 10). The caps 41 include a first cap 41A and a second cap 41B. The caps 42 include a first cap 42A and a second cap 42B. The caps 43 include a first cap 43A and a second cap 43B.

In a state in which the carriage 30 has moved to the left end of the movement path, the first cap 41A is positioned below the first head 31A. The second cap 41B is positioned below the second head 31B. The first cap 42A is positioned below the first head 32A. The second cap 42B is positioned below the second head 32B. The first cap 43A is positioned below the first head 33A. The second cap 43B is positioned below the second head 33B. Hereinafter, the position of the carriage 30 that has moved to the left end of the movement path is referred to as a reference position.

As a result of the support portion 40A moving upward in the state in which the carriage 30 is at the reference position, each of the first caps 41A to 43A is closely adhered to and covers the discharge portions 58A of the respective first heads 31A to 33A. Each of the second caps 41B to 43B is closely adhered to and covers the discharge portions 58B of the respective second heads 31B to 33B. During a period in which the printing is not performed on the print medium in the printer 1, the caps 4 suppress the ink from drying out, by covering the discharge portions 58A and 58B of the heads 3.

Cleaning Assembly 5

As illustrated in FIG. 3, the cleaning assembly 5 is positioned between the cap mechanism 40 and the platen 12 in the main scanning direction. The cleaning assembly 5 includes the cleaning assemblies 501, 502, and 503, and the cleaning assemblies 501, 502, and 503 are respectively positioned to the right of the caps 41 to 43, for example. The cleaning assemblies 501, 502, and 503 are aligned in the front-rear direction. The cleaning assembly 502 is positioned to the front of the cleaning assembly 501. The cleaning assembly 503 is positioned to the front of the cleaning assembly 502. The cleaning assemblies 501 to 503 have the same structure as each other. In FIG. 3, the cleaning assembly 501 includes a first wiper 601A, a second wiper 601B, and a perforated metal 59A. The cleaning assembly 502 includes a first wiper 602A, a second wiper 602B, and a perforated metal 59B. The cleaning assembly 503 includes a first wiper 603A, a second wiper 603B, and a perforated metal 59C. The first wipers 601A to 603A, the second wipers 601B to 603B, and each of the perforated metals 59A to 59C are respectively exposed upward.

The first wiper 601A wipes the discharge portion 58A of the first head 31A. The second wiper 601B wipes the discharge portion 58B of the second head 31B. At a time of a flushing operation, the perforated metal 59A allows the ink discharged from the first head 31A and the second head 31B to pass downward. The first wiper 602A wipes the discharge portion 58A of the first head 32A. The second wiper 602B wipes the discharge portion 58B of the second head 32B. At the time of the flushing operation, the perforated metal 59B allows the ink discharged from the first head 32A and the second head 32B to pass downward. The first wiper 603A wipes the discharge portion 58A of the first head 33A. The second wiper 603B wipes the discharge portion 58B of the second head 33B. At the time of the flushing operation, the perforated metal 59C allows the ink discharged from the first head 33A and the second head 33B to pass downward.

Hereinafter, when no distinction is made between the first wipers 601A, 602A, and 603A, they are collectively referred to as a first wiper 60A. When no distinction is made between the second wipers 601B, 602B, and 603B, they are collectively referred to as a second wiper 60B. When no distinction is made between the first wipers 60A and the second wipers 60B, they are collectively referred to as wipers 60. When no distinction is made between the perforated metals 59A, 59B, and 59C, they are collectively referred to as perforated metals 59.

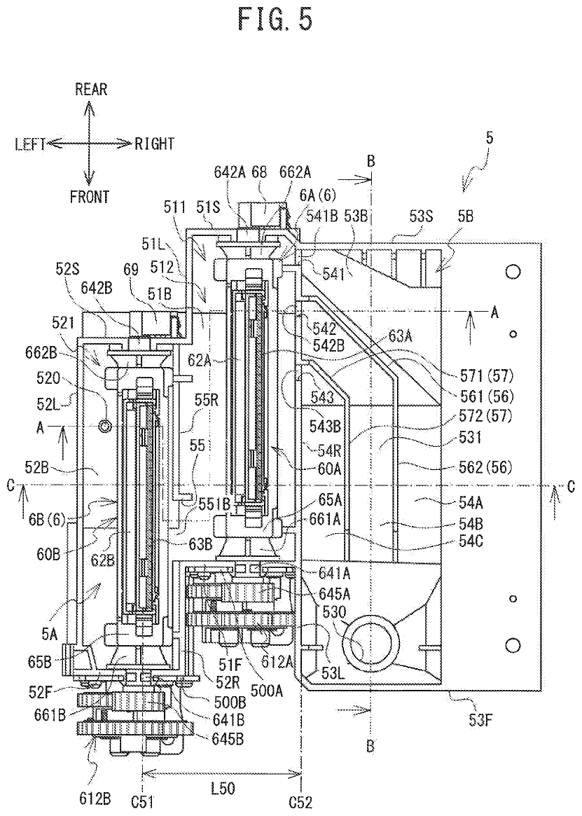

As illustrated in FIG. 4 and FIG. 5, the cleaning assembly 5 includes the cleaning fluid vessel 5A, the flushing box 5B, a first wipe mechanism 6A, and a second wipe mechanism 6B. Hereinafter, when no distinction is made between the first wipe mechanism 6A and the second wipe mechanism 6B, they are collectively referred to as a wipe mechanism 6. The cleaning fluid vessel 5A and the flushing box 5B are containers that can store the cleaning fluid. In FIG. 4 and FIG. 5, the perforated metals 59 illustrated in FIG. 3 are omitted.

Cleaning Fluid Vessel 5A

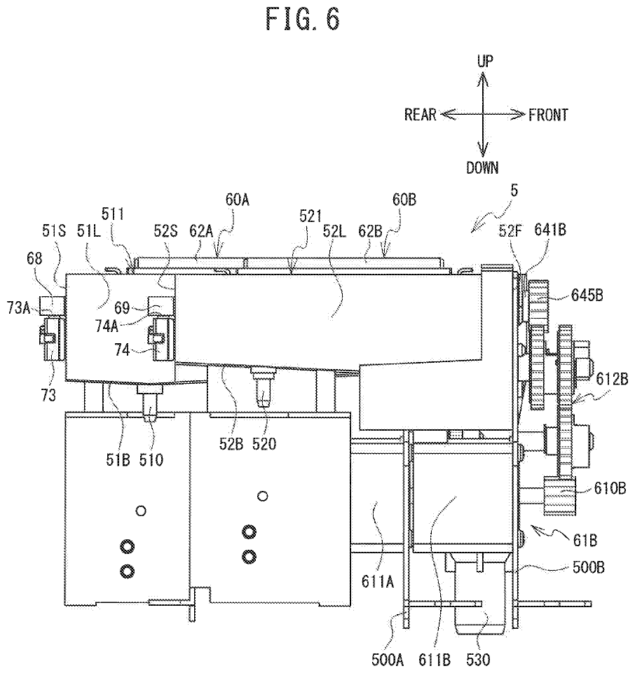

The cleaning fluid vessel 5A includes first peripheral walls 51L, 51F, 51S, 52L, 52F, 52S, and 52R, a first side wall 54R, first bottom walls 51B and 52B (refer to FIG. 5), an inflow port 520, and a discharge port 510 (refer to FIG. 6). The first peripheral walls 51L, 51F, 51S, 52L, 52F, 52S, and 52R, the first side wall 54R, and the first bottom walls 51B and 52B define a storage space 512 of the cleaning fluid. The cleaning fluid flows from the inflow port 520 into the storage space 512. The cleaning fluid stored in the storage space 512 is discharged from the discharge port 510.

The first peripheral wall 52L is provided at the left end of the cleaning fluid vessel 5A and is orthogonal to the left-right direction. The first peripheral wall 52F extends to the right from the front end of the first peripheral wall 52L, and is orthogonal to the front-rear direction. The first peripheral wall 52R extends to the rear from the right end of the first peripheral wall 52F, and is orthogonal to the left-right direction. The first peripheral wall 51F extends to the right from the rear end of the first peripheral wall 52R, and is orthogonal to the front-rear direction. The right end of the first peripheral wall 51F is connected to the rear end of a second peripheral wall 53L of the flushing box 5B to be described later. The first peripheral wall 52S extends to the right from the rear end of the first peripheral wall 52L, and is orthogonal to the front-rear direction. The first peripheral wall 51L extends to the rear from the right end of the first peripheral wall 52S, and is orthogonal to the left-right direction. The first peripheral wall 51S extends to the right from the rear end of the first peripheral wall 51L, and is orthogonal to the front-rear direction. The right end of the first peripheral wall 51S is connected to the left end of a second peripheral wall 53S of the flushing box 5B to be described later. The positions of the upper ends of each of the first peripheral walls 51L, 51F, 51S, 52L, 52F, 52S, and 52R are aligned in the up-down direction.

As illustrated in FIG. 4, a first support portion 513 is provided at the first peripheral wall 51F. The first support portion 513 is a recessed portion that is recessed downward from the upper end of the first peripheral wall 51F. A first support portion 514 is provided at the first peripheral wall 51S. The first support portion 514 is a recessed portion that is recessed downward from the upper end of the first peripheral wall 51S. The first support portions 513 and 514 rotatably support the first wiper 60A. A second support portion 523 is provided at the first peripheral wall 52F. The second support portion 523 is a recessed portion that is recessed downward from the upper end of the first peripheral wall 52F. A second support portion 524 is provided at the first peripheral wall 52S. The second support portion 524 is a recessed portion that is recessed downward from the upper end of the first peripheral wall 52S. The second support portions 523 and 524 rotatably support the second wiper 60B.

As illustrated in FIG. 5 and FIG. 6, the first bottom wall 52B is connected to the lower ends of the first peripheral walls 52L, 52F, and 52S. The inflow port 520 is provided at the rear end of the first bottom wall 52B. An inflow hose that is not illustrated is connected to the inflow port 520. The cleaning fluid that has flowed into the cleaning fluid vessel 5A via the inflow port 520 from the inflow hose is stored and held in the storage space 512. As illustrated in FIG. 6, an inclination is formed at the first wall portion 52B that becomes lower, in the front-rear direction, toward a second communicating portion 551.

The first bottom wall 51B is connected to the lower ends of the first peripheral walls 51L, 51F (refer to FIG. 4), and 51S. The discharge port 510 is provided at the rear end of the first bottom wall 51B. A discharge hose that is not illustrated is connected to the discharge port 510. The cleaning fluid that is stored in the storage space 512 of the cleaning fluid vessel 5A flows into the discharge hose via the discharge port 510, and is discharged to the outside. An inclination is formed at the first wall portion 51B that becomes lower toward a portion at which the discharge port 510 is provided.

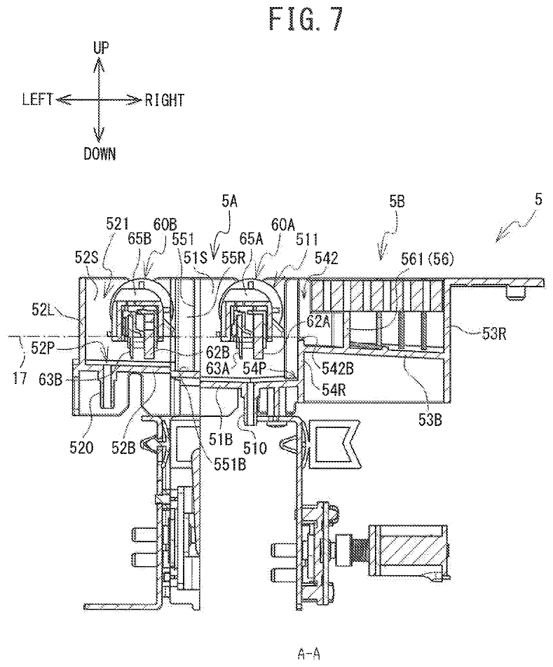

As illustrated in FIG. 6, respective positions of the first bottom walls 51B and 52B are different in the up-down direction. A step is formed between the first bottom walls 51B and 52B. As illustrated in FIG. 6 and FIG. 7, a portion of the first bottom wall 51B at which the discharge port 510 is provided is positioned lower, in the up-down direction, than a portion of the first bottom wall 52B at which the inflow port 520 is provided.

As illustrated in FIG. 4, a support wall 500A is fixed to a front surface of the first peripheral wall 51F. The support wall 500A extends further downward than the lower end of the first peripheral wall 51F. The support wall 500A supports a first power portion 61A to be described later. A support wall 500B is fixed to the first peripheral wall 52F. The support wall 500B extends further downward then the lower end of the first peripheral wall 52F. The support wall 500B supports a second power portion 61B to be described later.

As illustrated in FIG. 4, FIG. 5, and FIG. 7, the first side wall 54R extends upward from the right end of the first peripheral wall 51B, and is orthogonal to the left-right direction. As illustrated in FIG. 4, the first side wall 54R is connected to the right end of the first peripheral wall 51F and the right end of the first peripheral wall 51S. In the main scanning direction, the first side wall 54R is provided between the cleaning fluid vessel 5A and the flushing box 5B to be described later, and partitions the cleaning fluid vessel 5A and the flushing box 5B.

As illustrated in FIG. 4 and FIG. 5, the first side wall 54R includes first communicating portions 541, 542, and 543. The first communicating portions 541, 542, and 543 are arrayed in that order from the rear toward the front, and each of the first communicating portions 541, 542, and 543 is a portion that is cut out, downward, from the upper end of the first side wall 54R. The first communicating portions 541, 542, and 543 may be cut out downward to a height of the first bottom wall 51B, for example. The first communicating portions 541 to 543 are provided further to the rear than a central position, in the front-rear direction, of the first side wall 54R. A portion that is the lower end of the first communicating portion 541 and that corresponds to a bottom portion of the cut out shape is referred to as a first bottom portion 541B.

As illustrated in FIG. 7, positions of the first communicating portion 542 and the discharge port 510 of the cleaning fluid vessel 5A are aligned in the front-rear direction.

A portion that is the lower end of the first communicating portion 542 and that corresponds to a bottom portion of the cut out shape is referred to as a first bottom portion 542B. A portion that is the lower end of the first communicating portion 543 and that corresponds to a bottom portion of the cut out shape is referred to as a first bottom portion 543B. Positions of the first bottom portions 541B to 543B are the same in the up-down direction, and are disposed at positions lower than the upper ends of the first peripheral walls 51L, 51F, 51S, 52L, 52F, 52S, and 52R.

As illustrated in FIG. 7, a position 54P is disposed at a position lower than a position 52P. The position 54P is a position, of the first bottom wall 51B, below the first bottom portion 542B of the first communicating portion 542. The position 52P is a position at which the inflow port 520 is provided, of the first bottom wall 52B. When two virtual lines extending downward from both ends, in the front-rear direction, of the first bottom portion 542B of the first communicating portion 542 are defined, the position 54P is, for example, a position between two points at which the two virtual lines intersect the first bottom portion 51B. Although not illustrated, each of the first bottom portion 541B of the first communicating portion 541 and the first bottom portion 543B of the first communicating portion 543 also includes a position that is the same as the position 54P, and both these positions are also disposed at positions lower than the position 52P.

A virtual plane that extends horizontally at the height of the first bottom portions 541B, 542B, and 543B is referred to as a reference fluid surface 17.

As illustrated in FIG. 4 and FIG. 5, the second side wall 55R extends upward from the left end of the first bottom wall 51B, and connects to the right end of the first bottom wall 52B at a partway position. The second side wall 55R is orthogonal to the left-right direction. The rear end of the second side wall 55R is connected to the first peripheral wall 52S. The second side wall 55R includes the second communicating portion 551. The second communicating portion 551 is a portion that is cut out downward from the upper end of the second side wall 55R. As illustrated in FIG. 5, a portion that is the lower end of the second communicating portion 551 and that corresponds to a bottom portion of the cut out shape is referred to as a second bottom portion 551B. As illustrated in FIG. 7, the second bottom portion 551B is positioned lower than the portion, of the first bottom wall 52B, at which the inflow port 520 is provided, and is positioned higher than the portion, of the first bottom wall 51B, at which the discharge port 510 is provided. The second communicating portion 551 may be cut out downward to a height of the second bottom portion 551B, for example. It is preferable that the second communicating portion 551 be provided at a position close to the first peripheral wall 51F, in the front-rear direction. Further, the second bottom portion 551B is disposed at a position lower than the reference fluid surface 17 that corresponds to the height of the first bottom portions 541B, 542B, and 543B of the first communicating portions 541 to 543.

As illustrated in FIG. 5, the second side wall 55R divides, in the left-right direction, the storage space 512 surrounded by the first peripheral walls 51L, 51F, 51S, 52L, 52F, 52S, and 52R, the first bottom walls 51B and 52B, and the first side wall 54R. The divided portions are respectively referred to as a first section 511 and a second section 521. The first section 511 corresponds to a portion surrounded by the first peripheral walls 51L, 51F, and 51S, the first side wall 54R, the first bottom wall 51B, and the second side wall 55R. The second section 521 corresponds to a storage space surrounded by the first peripheral walls 52L, 52F, 52S, and 52R, the second side wall 55R, and the first bottom wall 52B. The second communicating portion 551 of the second side wall 55R causes the first section 511 and the second section 521 to be communicated with each other.

The second section 521 is positioned further to the left than the first section 511. Of three regions obtained by dividing the second section 521 into three equal sections in the front-rear direction, the region furthest to the front side is positioned, in the front-rear direction, further to the front than the front end of the first section 511. Of regions obtained by dividing the first section 511 into three equal sections in the front-rear direction, the region furthest to the rear side is positioned, in the front-rear direction, further to the rear than the rear end of the second section 521.

The second communicating portion 551 is positioned further to the front than a center position, in the front-rear direction, of the first section 511. On the other hand, the first communicating portions 541 and 542 are positioned further to the rear than the center position, in the front-rear direction, of the first section 511. Thus, the first communicating portions 541 and 542, and the second communicating portion 551 are separated in the front-rear direction.

The cleaning fluid that has flowed into the second section 521 of the cleaning fluid vessel 5A via the inflow port 520 moves to the front along the inclination of the first bottom wall 52B. The cleaning fluid passes through the second communicating portion 551 of the second side wall 55R, and moves into the first section 511 of the cleaning fluid vessel 5A. Further, in the first section 511, the cleaning fluid moves along the inclination of the first bottom wall 51B toward the discharge port 510 at the rear. The position 54P is disposed at a position lower than the position 52P, and thus, the cleaning fluid that has flowed into the cleaning fluid vessel 5A via the inflow port 520 further flows toward the vicinity of the first communicating portions 541 to 543. The fluid surface of the cleaning fluid that has accumulated in the cleaning fluid vessel 5A rises until it reaches the same height as the first bottom portions 541B, 542B, and 543B, and when the cleaning fluid flows further, the cleaning fluid flows into the flushing box 5B to be described later, via the first communicating portions 541 to 543. Thus, the fluid surface of the cleaning fluid that has flowed into the cleaning fluid vessel 5A is aligned with the height of the first bottom portions 541B, 542B, and 543B, and that height is the reference fluid surface 17.

Supply Mechanism 76A and Discharge Mechanism 76B

As illustrated in FIG. 4, a supply mechanism 76A that supplies the cleaning fluid to the cleaning fluid vessel 5A, and a discharge mechanism 76B that discharges the cleaning fluid from the cleaning fluid vessel 5A are provided. The supply mechanism 76A includes a pump 78, and a solenoid 77 (refer to FIG. 10). The pump 78 is provided partway along the inflow hose connected to the inflow port 520. The solenoid 77 opens and closes a valve provided between the inflow port 520 and the pump 78 in the inflow hose. When the solenoid 77 opens the valve during the driving of the pump 78, the cleaning fluid of a cleaning fluid tank that is not illustrated flows into the inflow hose and into the cleaning fluid vessel 5A via the inflow port 520, in accordance with a pressure generated by the pump 78.

The discharge mechanism 76B includes a solenoid 79 (refer to FIG. 10) that opens and closes a valve provided in the discharge hose connected to the discharge port 510. When the solenoid 79 opens the valve in a state in which the cleaning fluid is stored in the cleaning fluid vessel 5A, the cleaning fluid is discharged to the outside via the discharge port 510.

Flushing Box 5B

As illustrated in FIG. 4 and FIG. 5, the flushing box 5B is connected to the right side of the cleaning fluid vessel 5A. The flushing box 5B receives the ink discharged from the heads 3 by the flushing operation. The flushing box 5B is communicated with the cleaning fluid vessel 5A via the first communicating portions 541 to 543 of the first side wall 54R.

The flushing box 5B includes second peripheral walls 53L, 53F, 53S, and 53R, a second bottom wall 53B, a waste liquid port 530, and flow path walls 56 and 57. The second peripheral wall 53L extends to the front from the right end of the first peripheral wall 51F, and is orthogonal to the left-right direction. The second peripheral wall 53F extends to the right from the front end of the second peripheral wall 53L, and is orthogonal to the front-rear direction. The second peripheral wall 53S extends to the right from the right end of the first peripheral wall 51S, and is orthogonal to the front-rear direction. The second peripheral wall 53R extends between the respective right ends of the second peripheral walls 53F and 53S, and is orthogonal to the left-right direction. The positions of the upper ends of each of the second peripheral walls 53L, 53F, 53S, and 53R are the same in the up-down direction.

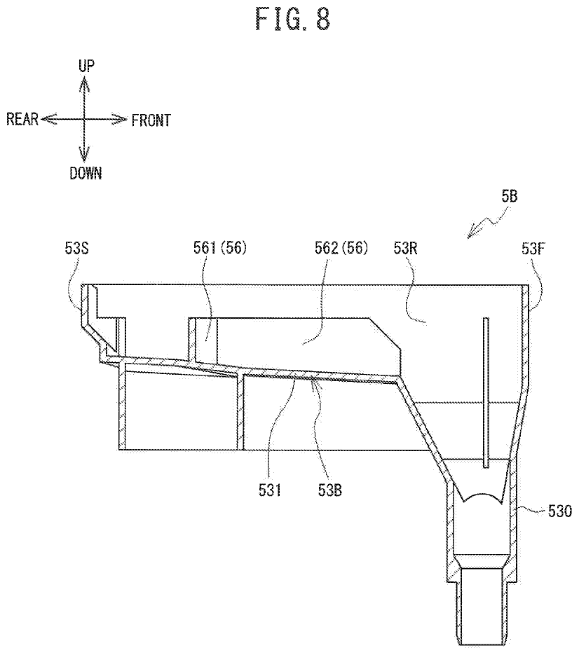

As illustrated in FIG. 8, the second bottom wall 53B is connected to the lower ends of the second peripheral walls 53L (refer to FIG. 4), 53F, 53S, and 53R. As illustrated in FIG. 7, the second bottom wall 53B is connected to the right surface of the first side wall 54R that extends upward from the first bottom wall 51B of the cleaning fluid vessel 5A. The second bottom wall 53B is positioned higher than the first bottom walls 51B and 52B in the up-down direction.

As illustrated in FIG. 4 and FIG. 5, the waste liquid port 530, and an inclined section 531 are provided at the second bottom wall 53B. The waste liquid port 530 is provided in the vicinity of the front end of the second bottom wall 53B. The waste liquid port 530 causes the cleaning fluid in the flushing box 5B to flow to the outside. Note that, in the front-rear direction, the first communicating portions 541 to 543 of the first side wall 54R are positioned in the vicinity of the rear end of the flushing box 5B. Thus, the waste liquid port 530 provided in the vicinity of the front end of the second bottom wall 53B and the first communicating portions 541 to 543 are separated in the front-rear direction.

As illustrated in FIG. 8, the inclined section 531 is positioned, in the front-rear direction, between the first communicating portions 541 to 543 (refer to FIG. 4) of the first side wall 54R and the waste liquid port 530. The inclined section 531 is inclined such that it becomes lower from the rear end thereof in the vicinity of the first communicating portions 541 to 543 toward the front end thereof in the vicinity of the waste liquid port 530. The inclined section 531 causes the ink discharged into the flushing box 5B by the flushing operation, and the cleaning fluid that has flowed into the flushing box 5B via the first communicating portions 541 to 543 of the first side wall 54R to flow toward the waste liquid port 530.

As illustrated in FIG. 4 and FIG. 5, the flow path walls 56 and 57 extend upward from the second bottom wall 53B. The flow path walls 56 and 57 define a flow path of the cleaning fluid from the first communicating portions 541 to 543 toward the waste liquid port 530. As illustrated in FIG. 5, the flow path wall 56 includes a first extension portion 561 and a second extension portion 562. The first extension portion 561 extends diagonally to the right and to the front from the rear side of a section, of the first side wall 54R, at which the first communicating portion 542 is provided. The second extension portion 562 extends to the front from the front end of the first extension portion 561, to the vicinity of the waste liquid port 530. The flow path wall 57 includes a first extension portion 571 and a second extension portion 572. The first extension portion 571 extends diagonally to the right and to the front from the rear side of a section, of the first side wall 54R, at which the first communicating portion 543 is provided. The second extension portion 572 extends to the front from the front end of the first extension portion 571, to the vicinity of the waste liquid port 530. As illustrated in FIG. 4, in the up-down direction, the upper ends of the flow path walls 56 and 57 are positioned lower than the upper ends of the second peripheral walls 53L, 53F, 53S, and 53R, and higher than the first bottom portions 541B, 542B, and 543B of the first communicating portions 541 to 543.

As illustrated in FIG. 5, of an internal region of the flushing box 5B, a region surrounded by the second peripheral walls 53S and 53R (refer to FIG. 4) and the flow path wall 56 defines a flow path 54A corresponding to the first communicating portion 541. Of the internal region of the flushing box 5B, a region surrounded by the flow path walls 56 and 57 defines a flow path 54B corresponding to the first communicating portion 542. Of the internal region of the flushing box 5B, a region surrounded by the first side wall 54R and the flow path wall 56 defines a flow path 54C corresponding to the first communicating portion 543. Of the flow paths 54A, 54B, and 54C, sections that extend in the front-rear direction along the second extension portions 562 and 572 are disposed side by side in the main scanning direction. Thus, the flow paths 54A, 54B, and 54C can cause the ink or the cleaning fluid of the inclined section 531 to be dispersed and to flow in the main scanning direction.

Wipe Mechanism 6

Hereinafter, wiping the discharge portion 58A of the first head 3A can be referred to as wiping the first head 3A. Wiping the discharge portion 58B of the second head 3B can be referred to as wiping the second head 3B. As illustrated in FIG. 4 and FIG. 5, the first wipe mechanism 6A includes the first wiper 60A and the first power portion 61A. The first wiper 60A wipes the first head 3A by coming into contact with the discharge portion 58A of the first head 3A. The first power portion 61A moves the position of the first wiper 60A between a first contact position (refer to FIG. 4) and a first non-contact position (refer to FIG. 7) to be described later. The second wipe mechanism 6B includes the second wiper 60B and the second power portion 61B. The second wiper 60B wipes the second head 3B by coming into contact with the discharge portion 58B of the second head 3B. The second power portion 61B moves the position of the second wiper 60B between a second contact position (refer to FIG. 4) and a second non-contact position (refer to FIG. 7) to be described later. The first wipe mechanism 6A and the second wipe mechanism 6B have the same configuration. Hereinafter, insofar as there is no particular description thereof, each of directions are defined by a state in which the first wiper 60A is disposed at the first contact position and the second wiper 60B is disposed at the second contact position.

The first wiper 60A of the first wipe mechanism 6A includes a first foam wiper 62A, a first rubber wiper 63A, and a base portion 65A. The base portion 65A is housed in the first section 511 of the cleaning fluid vessel 5A and extends in the front-rear direction. As illustrated in FIG. 5, a sealing portion 661A is provided at the front end of the base portion 65A. The sealing portion 661A includes a circular flat surface portion at the front end thereof. The flat surface portion is orthogonal to the front-rear direction. A rotation shaft 641A extends from the flat surface portion of the sealing portion 661A toward the front. As illustrated in FIG. 4, the rotation shaft 641A enters into the first support portion 513 of the first peripheral wall 51F from the rear, and protrudes to the front. As illustrated in FIG. 5, a sealing portion 662A is provided at the rear end of the base portion 65A. The sealing portion 662A includes a circular flat surface portion at the rear end thereof. The flat surface portion is orthogonal to the front-rear direction. A rotation shaft 642A extends from the flat surface portion of the sealing portion 662A toward the rear. The rotation shaft 642A enters into the first support portion 514 (refer to FIG. 4) of the first peripheral wall 51S from the front, and protrudes to the rear.

The rotation shafts 641A and 642A are rotatably supported by the first support portions 513 and 514. Thus, the first wiper 60A is rotatably supported by the first support portions 513 and 514, via the rotation shafts 641A and 642A. The sealing portions 661A and 662A suppress the cleaning fluid stored in the storage space 512 of the cleaning fluid vessel 5A from flowing out via the first support portions 513 and 514.

As illustrated in FIG. 4 and FIG. 5, of the rotation shaft 641A, a section that protrudes further to the front than the first peripheral wall 51F is coupled to a gear 645A. The gear 645A meshes with a first gear group 612A of the first power portion 61A to be described later. Of the rotation shaft 642A, a section that protrudes further to the rear than the first peripheral wall 51S is coupled to a rotator 68. The rotator 68 can come into contact with a contactor 73A (refer to FIG. 6) of a first sensor 73 to be described later.

The first foam wiper 62A and the first rubber wiper 63A are held by the base portion 65A. The first foam wiper 62A has a plate shape that is long in the front-rear direction, and is orthogonal to the left-right direction. The first foam wiper 62A is a wiper formed of a porous material, such as a resin foam or the like, and has absorbent properties. The first rubber wiper 63A is disposed to the right of the first foam wiper 62A. The first rubber wiper 63A includes a plate-shaped support portion that is long in the front-rear direction, and extends upward from the support portion. A groove that extends in the up-down direction is formed in the right surface of the first rubber wiper 63A. The first rubber wiper 63A is made of rubber. A section of the first foam wiper 62A from the center thereof in the up-down direction to the lower end thereof, and the support portion of the first rubber wiper 63A are held by the base portion 65A. A section of the first foam wiper 62A from the center thereof in the up-down direction to the upper end thereof, and a plurality of protrusions of the first rubber wiper 63A protrude upward from the base portion 65A. Hereinafter, insofar as there is no particular description thereof, it is assumed that the first foam wiper 62A and the first rubber wiper 63A indicate, of the whole of the respective members, the sections thereof protruding from the base portion 65A. Each of the upper ends of the first foam wiper 62A and the first rubber wiper 63A are referred to as a tip end.

As illustrated in FIG. 4 and FIG. 5, the second wiper 60B of the second wipe mechanism 6B includes a second foam wiper 62B, a second rubber wiper 63B, and a base portion 65B. The base portion 65B is housed in the second section 521 of the cleaning fluid vessel 5A and extends in the front-rear direction. As illustrated in FIG. 5, a sealing portion 661B is provided at the front end of the base portion 65B. The sealing portion 661B includes a circular flat surface portion at the front end thereof. The flat surface portion is orthogonal to the front-rear direction. A rotation shaft 641B extends from the flat surface portion of the sealing portion 661B toward the front. As illustrated in FIG. 4, the rotation shaft 641B enters into the second support portion 523 of the first peripheral wall 52F from the rear, and protrudes to the front. As illustrated in FIG. 5, a sealing portion 662B is provided at the rear end of the base portion 65B. The sealing portion 662B includes a circular flat surface portion at the rear end thereof. The flat surface portion is orthogonal to the front-rear direction. A rotation shaft 642B extends from the flat surface portion of the sealing portion 662B toward the rear. The rotation shaft 642B enters into the second support portion 524 (refer to FIG. 4) of the first peripheral wall 52S from the front, and protrudes to the rear.

The rotation shafts 641B and 642B are rotatably supported by the second support portions 523 and 524. Thus, the second wiper 60B is rotatably supported by the second support portions 523 and 524, via the rotation shafts 641B and 642B. The sealing portions 661B and 662B suppress the cleaning fluid stored in the storage space 512 of the cleaning fluid vessel 5A from flowing out via the second support portions 523 and 524.

As illustrated in FIG. 4 and FIG. 5, of the rotation shaft 641B, a section that protrudes further to the front than the first peripheral wall 52F is coupled to a gear 645B. The gear 645B meshes with a second gear group 612B of the second power portion 61B to be described later. Of the rotation shaft 642B, a section that protrudes further to the rear than the first peripheral wall 52S is coupled to a rotator 69. The rotator 69 can come into contact with a contactor 74A (refer to FIG. 6) of a second sensor 74 to be described later.

The second foam wiper 62B and the second rubber wiper 63B are held by the base portion 65B. The second foam wiper 62B is formed of the same material and has the same shape as the first foam wiper 62A. The second rubber wiper 63B is formed of the same material and has the same shape as the first rubber wiper 63A. Hereinafter, insofar as there is no particular description thereof, it is assumed that the second foam wiper 62B and the second rubber wiper 63B indicate, of the whole of the respective members, the sections thereof protruding from the base portion 65B. Each of the upper ends of the second foam wiper 62B and the second rubber wiper 63B are referred to as a tip end.

Of two respective regions obtained by dividing the first wiper 60A into two equal sections in the front-rear direction, a region on the front side overlaps, in the sub-scanning direction, with a region on the rear side, of two respective regions obtained by dividing the second wiper 60B into two equal sections in the front-rear direction. In other words, the front end of the first wiper 60A is positioned between the front end and the rear end of the second wiper 60B in the sub-scanning direction. The rear end of the second wiper 60B is positioned between the front end and the rear end of the first wiper 60A in the sub-scanning direction. The overlapping region of the first wiper 60A and the second wiper 60B in the sub-scanning direction is referred to as a wiper overlap region. An overlapping region of the discharge portion 58A of the first head 31A and the discharge portion 58B of the second head 31B in the sub-scanning direction is referred to as a head overlap region. In the sub-scanning direction, respective positions of the front end of the wiper overlap region and the front end of the head overlap region are aligned, or the front end of the wiper overlap region is positioned further to the front. In the sub-scanning direction, the rear end of the wiper overlap region and the rear end of the head overlap region are aligned, or the rear end of the wiper overlap region is positioned further to the rear. In other words, the wiper overlap region and the head overlap region overlap in the sub-scanning direction.

As illustrated in FIG. 5, a position C51 of the center, in the main scanning direction, of the second wiper 60B is defined. A position C52 of the left end of the flushing box 5B is defined. An interval between the positions C51 and C52 is defined as an interval L50 between the second wiper 60B and the flushing box 5B in the main scanning direction. At this time, the interval L30 (refer to FIG. 3) between the first head 3A and the second head 3B in the main scanning direction is greater than the interval L50.

As illustrated in FIG. 4 and FIG. 5, the first power portion 61A is provided with a first motor 611A (refer to FIG. 6) and the first gear group 612A. The first motor 611A is provided below the first section 511 of the cleaning fluid vessel 5A, and is fixed to the rear surface of the support wall 500A. The first motor 611A is, for example, a stepping motor. A rotation shaft of the first motor 611A is inserted, from the rear, through a hole provided in the support wall 500A, and protrudes further to the front than the support wall 500A. The first gear group 612A includes a plurality of gears arrayed in the up-down direction. The first gear group 612A is rotatably supported by the support wall 500A. The gear positioned lowermost, of the first gear group 612A, meshes with a gear 610A coupled to the rotation shaft of the first motor 611A. The gear positioned uppermost, of the first gear group 612A, meshes with the gear 645A coupled to the rotation shaft 641A of the first wiper 60A.

The first gear group 612A transmits the power of the first motor 611A to the first wiper 60A, and causes the first wiper 60A to rotate. Due to the rotation, the first wiper 60A moves between the first contact position (refer to FIG. 4) and the first non-contact position (refer to FIG. 7). A rotation direction when the first wiper 60A rotates from the first contact position to the first non-contact position is not limited, but in the present embodiment, the rotation direction is the counter-clockwise direction as seen from the front. A rotation direction when the first wiper 60A rotates from the first non-contact position to the first contact position is not limited, but in the present embodiment, the rotation direction is the clockwise direction as seen from the front.

The second power portion 61B is provided with a second motor 611B and the second gear group 612B. The second motor 611B is provided below the second section 521 of the cleaning fluid vessel 5A, and is fixed to the rear surface of the support wall 500B. The second motor 611B is, for example, a stepping motor. A rotation shaft of the second motor 611B is inserted, from the rear, through a hole provided in the support wall 500B, and protrudes further to the front than the support wall 500B. The second gear group 612B includes a plurality of gears arrayed in the up-down direction. The second gear group 612B is rotatably supported by the support wall 500B. The gear positioned lowermost, of the second gear group 612B, meshes with a gear 610B coupled to the rotation shaft of the second motor 611B. The gear positioned uppermost, of the second gear group 612B, meshes with the gear 645B coupled to the rotation shaft 641B of the second wiper 60B.

The second gear group 612B transmits the power of the second motor 611B to the second wiper 60B, and causes the second wiper 60B to rotate. Due to the rotation, the second wiper 60B moves between the second contact position (refer to FIG. 4) and the second non-contact position (refer to FIG. 7). A rotation direction when the second wiper 60B rotates from the second contact position to the second non-contact position is not limited, but in the present embodiment, the rotation direction is the counter-clockwise direction as seen from the front. A rotation direction when the second wiper 60B rotates from the second non-contact position to the second contact position is not limited, but in the present embodiment, the rotation direction is the clockwise direction as seen from the front.

Contact Positions

As illustrated in FIG. 4, the second foam wiper 62B, the second rubber wiper 63B, the first foam wiper 62A, and the first rubber wiper 63A are aligned in this order from the left to the right. The tip ends of the first foam wiper 62A and the first rubber wiper 63A that are at the first contact position, and of the second foam wiper 62B and the second rubber wiper 63B that are at the second contact position are oriented upward, respectively, and protrude higher than the upper ends of the first peripheral walls 51L, 51F, 51S, 52L, 52F, 52S, and 52R (refer to FIG. 4) of the cleaning fluid vessel 5A. In other words, the first contact position is a position at which the first foam wiper 62A and the first rubber wiper 63A protrude upward and can come into contact with the discharge portion 58A of the first head 3A. The second contact position is a position at which the second foam wiper 62B and the second rubber wiper 63B protrude upward and can come into contact with the discharge portion 58B of the second head 3B. At the first contact position and the second contact position, the first foam wiper 62A, the first rubber wiper 63A, the second foam wiper 62B, and the second rubber wiper 63B are respectively positioned higher than the reference fluid surface 17. Thus, when the cleaning fluid is stored in the storage space 512 of the cleaning fluid vessel 5A, each of the first foam wiper 62A, the first rubber wiper 63A, the second foam wiper 62B, and the second rubber wiper 63B is not in contact with the cleaning fluid. Hereinafter, when no distinction is made between the first contact position and the second contact position, they are collectively referred to as the contact positions.

Non-Contact Positions

As illustrated in FIG. 7, the tip ends of the first foam wiper 62A and the first rubber wiper 63A that are at the first non-contact position, and of the second foam wiper 62B and the second rubber wiper 63B that are at the second non-contact position are oriented downward, respectively. The first foam wiper 62A, the first rubber wiper 63A, the second foam wiper 62B, and the second rubber wiper 63B are respectively positioned lower than the upper ends of the first peripheral walls 51L, 51F, 51S, 52L, 52F, 52S, and 52R (refer to FIG. 4) of the cleaning fluid vessel 5A. In other words, the first non-contact position is a position at which the first foam wiper 62A and the first rubber wiper 63A are oriented downward and cannot come into contact with the discharge portion 58A of the first head 3A. The second non-contact position is a position at which the second foam wiper 62B and the second rubber wiper 63B are oriented downward and cannot come into contact with the discharge portion 58B of the second head 3B. At the first non-contact position and the second non-contact position, the first wiper 60A is housed in the first section 511 of the cleaning fluid vessel 5A and the second wiper 60B is housed in the second section 521 of the cleaning fluid vessel 5A.

The first foam wiper 62A and the first rubber wiper 63A that are at the first non-contact position, and the second foam wiper 62B and the second rubber wiper 63B that are at the second non-contact position are respectively positioned lower than the reference fluid surface 17. Thus, when the cleaning fluid is stored in the storage space 512 of the cleaning fluid vessel 5A, the first foam wiper 62A, the first rubber wiper 63A, the second foam wiper 62B, and the second rubber wiper 63B are respectively in contact with the cleaning fluid. Hereinafter, when no distinction is made between the first non-contact position and the second non-contact position, they are collectively referred to as the non-contact positions. At the non-contact positions, it is sufficient that each of the wipers 62A, 63A, 62B, and 63B is not in contact with each of the discharge portions 58A and 58B of the heads 3A and 3B, and that the wipers 62A, 63A, 62B, and 63B are not oriented downward, such as being oriented horizontally or the like.

Intermediate Positions

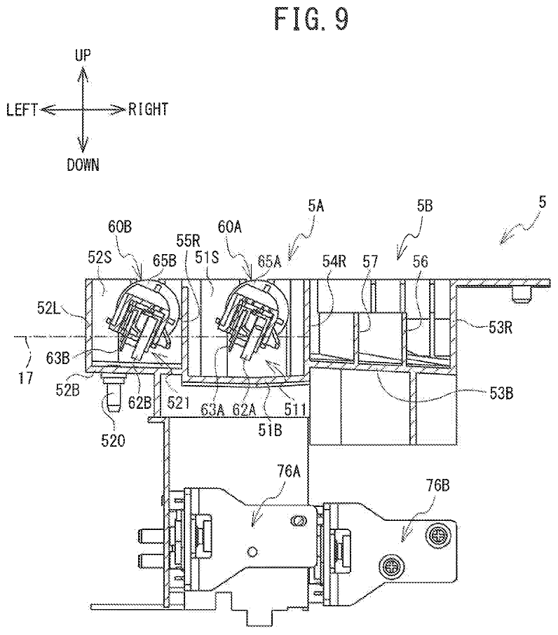

FIG. 9 illustrates a state in which the first wiper 60A is positioned at a first intermediate position and the second wiper 60B is positioned at a second intermediate position. The first intermediate position is a position between the first contact position (refer to FIG. 4) and the first non-contact position (refer to FIG. 7). For example, when seen from the front, the first intermediate position is a position at which the first wiper 60A has rotated by approximately 30° in the clockwise direction from the first non-contact position. The second intermediate position is a position between the second contact position (refer to FIG. 4) and the second non-contact position (refer to FIG. 7). For example, when seen from the front, the second intermediate position is a position at which the second wiper 60B has rotated by approximately 30° in the clockwise direction from the second non-contact position. Hereinafter, when no distinction is made between the first intermediate position and the second intermediate position, they are collectively referred to as intermediate positions.

The tip ends of each of the first foam wiper 62A, the first rubber wiper 63A, the second foam wiper 62B, and the second rubber wiper 63B that are at the intermediate positions are oriented diagonally downward and to the left. The first foam wiper 62A, the first rubber wiper 63A, the second foam wiper 62B, and the second rubber wiper 63B are respectively positioned lower than the reference fluid surface 17. Thus, when the cleaning fluid is stored in the storage space 512 of the cleaning fluid vessel 5A, each of the first foam wiper 62A, the first rubber wiper 63A, the second foam wiper 62B, and the second rubber wiper 63B is in contact with the cleaning fluid.

First Sensor 73, Second Sensor 74

As illustrated in FIG. 6, the first sensor 73 is provided at the rear surface of the first peripheral wall 51S of the cleaning fluid vessel 5A and the second sensor 74 is provided at the rear surface of the first peripheral wall 52S. The first sensor 73 and the second sensor 74 are contact-type position sensors provided, respectively, with the contactors 73A and 74A that protrude upward.

In a state in which the first wiper 60A is at the first contact position, the rotator 68 is in contact, from above, with the contactor 73A of the first sensor 73. Since the rotator 68 is formed protruding from an axial center of the rotation shaft 642A only partially in the radial direction, when the first wiper 60A moves from the first contact position to the first non-contact position, the rotator 68 rotates in the clockwise direction as seen from the rear, and separates from the contactor 73A of the first sensor 73. In other words, in a state in which the first wiper 60A is not at the first contact position, the rotator 68 is separated from the contactor 73A of the first sensor 73, to the left.

In a state in which the second wiper 60B is at the second contact position, the rotator 69 is in contact, from above, with the contactor 74A of the second sensor 74. Since the rotator 69 is formed protruding from an axial center of the rotation shaft 642B only partially in the radial direction, when the second wiper 60B moves from the second contact position to the second non-contact position, the rotator 69 rotates in the clockwise direction as seen from the rear, and separates from the contactor 74A of the second sensor 74. In other words, in a state in which the second wiper 60B is not at the second contact position, the rotator 69 is separated from the contactor 74A of the second sensor 74, to the left.

Electrical Configuration

The electrical configuration of the printer 1 will be described with reference to FIG. 10. The printer 1 is provided with a CPU 80 that controls the printer 1. A ROM 81, a RAM 82, a head drive portion 83A, a main scanning drive portion 83B, a sub-scanning drive portion 83C, a cap drive portion 83D, an ASIC 84, a display control portion 151, an operation processing portion 152, the supply mechanism 76A, the discharge mechanism 76B, the first motor 611A, the second motor 611B, the first sensor 73, and the second sensor 74 are electrically connected to the CPU 80 via a bus 80A.

A control program used by the CPU 80 to control operations of the printer 1, default values, and the like are stored in the ROM 81. Various data, flags and the like used by the control program are temporarily stored in the RAM 82. The ASIC 84 controls the head drive portion 83A, the main scanning drive portion 83B, the sub-scanning drive portion 83C, and the cap drive portion 83D. The head drive portion 83A drives piezoelectric elements provided in the heads 3 (the first head 3A and the second head 3B) that discharge the ink, and causes the ink to be discharged from ink nozzles. The main scanning drive portion 83B includes at least a main scanning motor 831B, and moves the carriage 30 in the main scanning direction by driving of the main scanning motor 831B. The sub-scanning drive portion 83C includes at least the platen motor 831C, and moves the platen 12 and the tray 13 (refer to FIG. 1) in the sub-scanning direction by the driving of the platen motor 831C. The cap drive portion 83D includes at least a cap motor 831D, and moves the cap mechanism 40 in the up-down direction by the driving of the cap motor 831D. The main scanning motor 831B, the platen motor 831C, and the cap motor 831D are stepping motors.

The display control portion 151 drives the display 15A of the operation portion 15, under the control of the CPU 80, and causes an image to be displayed. The operation processing portion 152 detects an operation on the operation buttons 15B of the operation portion 15. The pump 78 of the supply mechanism 76A supplies the cleaning fluid to the cleaning fluid vessel 5A via the inflow hose between cleaning fluid vessel 5A and the inflow port 520. A tube pump is used as the pump 78, for example. The solenoid 77 opens and closes the value provided at the inflow hose. The solenoid 79 of the discharge mechanism 76B opens and closes the valve provided at the discharge hose connected to the discharge port 510. As a result of being driven, the first motor 611A moves the first wiper 60A between the first contact position and the first non-contact position. As a result of being driven, the second motor 611B moves the second wiper 60B between the second contact position and the second non-contact position. The first sensor 73 outputs an ON signal in the state in which the rotator 68 is in contact with the contactor 73A, and outputs an OFF signal in the state in which the rotator 68 is not in contact with the contactor 73A. The second sensor 74 outputs an ON signal in the state in which the rotator 69 is in contact with the contactor 74A, and outputs an OFF signal in the state in which the rotator 69 is not in contact with the contactor 74A.

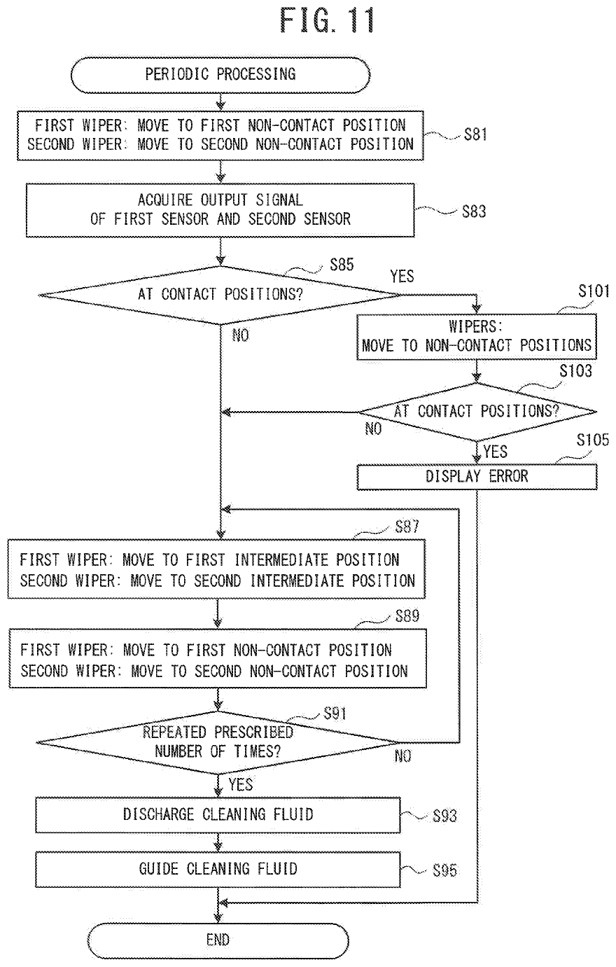

Periodic processing Periodic processing performed by the CPU 80 of the printer 1 will be described with reference to FIG. 11. By reading out and executing the control program stored in the ROM 81 at a predetermined period (24 hours, for example), the CPU 80 periodically executes the periodic processing. Note that, at the start of the periodic processing, it is assumed that the cleaning fluid is held in the cleaning fluid vessel 5A, the solenoid 77 of the supply mechanism 76A closes the valve of the inflow hose connected to the inflow port 520, the driving of the pump 78 is stopped, and the solenoid 79 of the discharge mechanism 76B closes the value of the discharge hose connected to the discharge port 510.

The CPU 80 drives the first motor 611A and moves the first wiper 60A to the first non-contact position, and drives the second motor 611B and moves the second wiper 60B to the second non-contact position (step S81). The movement of the first wiper 60A and the second wiper 60B may be started at the same time, or the movement of one of the first wiper 60A or the second wiper 60B may be started in advance of the other. The CPU 80 starts processing to acquire the signals output by the first sensor 73 and the second sensor 74 at a predetermined period (one second, for example) (step S83). The CPU 80 determines whether at least one of the first wiper 60A and the second wiper 60B is at the contact position (step S85). When the CPU 80 acquires the OFF signal as the signal output by the first sensor 73, and acquires the OFF signal as the signal output by the second sensor 74, the CPU 80 determines that the first wiper 60A is not positioned at the first contact position and the second wiper 60B is not positioned at the second contact position (no at step S85). In this case, the CPU 80 determines that the movement of the wipers 60 to the non-contact positions by the processing at step S81 is successful, and advances the processing to step S87.

When the CPU 80 acquires the ON signal from at least one of the first sensor 73 and the second sensor 74, the CPU 80 determines that at least one of the first wiper 60A and the second wiper 60B is at the contact position (yes at step S85). In this case, the CPU 80 determines that the movement of the wipers 60 to the non-contact positions by the processing at step S81 has failed, and once more moves the wipers 60 to the non-contact positions. The CPU 80 drives the first motor 611A and the second motor 611B corresponding to the first wiper 60A and the second wiper 60B determined to be at the contact positions, and moves the first wiper 60A and the second wiper 60B that are at the contact positions to the non-contact positions (step S101).

The CPU 80 determines whether at least one of the first wiper 60A and the second wiper 60B is at the contact position (step S103). When the CPU 80 acquires the ON signal as the signal output by at least one of the first sensor 73 and the second sensor 74, the CPU 80 determines that at least one of the first wiper 60A and the second wiper 60B is at the contact position (yes at step S103). In this case, even if the processing to move the wipers 60 to the non-contact positions at step S81 and step S101 has been repeated, at least one of the first wiper 60A and the second wiper 60B is positioned at the contact position. In this case, the CPU 80 displays, on the display 15A, an error message notifying that it has not been possible to move at least one of the first wiper 60A and the second wiper 60B to the non-contact position (step S105). The CPU 80 ends the periodic processing.

On the other hand, when the CPU 80 receives the OFF signal as the signal output by the first sensor 73 and receives the OFF signal as the signal output by the second sensor 74, the CPU 80 determines that the first wiper 60A is not positioned at the first contact position, and that the second wiper 60B is not positioned at the second contact position (no at step S103). In this case, the CPU 80 determines that the movement of the wipers 60 to the non-contact positions by the processing at step S101 is successful, and advances the processing to step S87.

The CPU 80 drives the first motor 611A and moves the first wiper 60A to the first intermediate position, and drives the second motor 611B and moves the second wiper 60B to the second intermediate position (step S87, refer to FIG. 9). Next, the CPU 80 drives the first motor 611A and moves the first wiper 60A to the first non-contact position, and drives the second motor 611B and moves the second wiper 60B to the second non-contact position (step S89, refer to FIG. 9). At step S87 and step S89, the movement of the first wiper 60A and the second wiper 60B may be started at the same time, or the movement of one of the first wiper 60A or the second wiper 60B may be started in advance of the other.

By the processing at step S87 and step S89, the first wiper 60A and the second wiper 60B reciprocate between the non-contact positions and the intermediate positions, in a state of being in contact with the cleaning fluid at positions below the reference fluid surface 17. In this way, the first wiper 60A and the second wiper 60B are cleaned by the cleaning fluid. Further, by the movement of the first wiper 60A and the second wiper 60B, the fluid surface of the cleaning fluid fluctuates. In this way, the cleaning fluid in the cleaning fluid vessel 5A flows into the flushing box 5B via the first communicating portions 541 to 543 of the first side wall 54R. The cleaning fluid flows toward the waste liquid port 530 along the flow paths 54A to 54C of the flushing box 5B, and cleans the second bottom wall 53B of the flushing box 5B. After that, the cleaning fluid is discharged from the waste liquid port 530.

By repeating the processing at step S87 and step S89 a prescribed number of times (ten times, for example), the CPU 80 determines whether the first wiper 60A and the second wiper 60B have been moved between the non-contact positions and the intermediate positions the prescribed number of times (step S91). When the number of times that the processing at step S87 and step S89 has been repeated is less than the prescribed number of times (no at step S91), the CPU 80 returns the processing to step S87, and repeats the processing at step S87 and step S89. When the number of times that the processing at step S87 and step S89 has been repeated is equal to or greater than the prescribed number of times (yes at step S91), the CPU 80 advances the processing to step S93.

By repeating the processing at step S87 and step S89, the first wiper 60A, the second wiper 60B, and the flushing box 5B are cleaned by the cleaning fluid. Further, impurities, such as pigment particles and the like in the ink that have precipitated inside the cleaning fluid vessel 5A are agitated by the movement of the first wiper 60A and the second wiper 60B, and are caused to float in the cleaning fluid.

The CPU 80 drives the solenoid 79 of the discharge mechanism 76B, and opens the valve of the discharge hose connected to the discharge port 510. In this way, the CPU 80 discharges the cleaning fluid stored in the storage space 512 of the cleaning fluid vessel 5A (step S93). At this time, the impurities in the state of floating in the cleaning fluid are also discharged along with the cleaning fluid. After discharging the cleaning fluid, the CPU 80 drives the solenoid 77 of the supply mechanism 76A and opens the valve of the inflow hose connected to the inflow port 520. The CPU 80 starts the driving of the pump 78 of the supply mechanism 76A. In this way, the CPU 80 supplies the cleaning fluid supplied by the pump 78 to the cleaning fluid vessel 5A via the inflow port 520 (step S95).

The amount of the cleaning fluid supplied to the cleaning fluid vessel 5A by the processing at step S95 is greater than the amount of the cleaning fluid discharged from the cleaning fluid vessel 5A by the processing at step S93. Thus, even if the cleaning fluid inside the cleaning fluid vessel 5A accumulates and the fluid surface reaches the reference fluid surface 17, the cleaning fluid is additionally supplied to the cleaning fluid vessel 5A. As a result, the cleaning fluid flows into the flushing box 5B via the first communicating portions 541 to 543. The cleaning fluid flows along the flow paths 54A to 54C of the flushing box 5B, and cleans the second bottom wall 53B of the flushing box 5B. After a predetermined amount of the cleaning fluid is supplied to the cleaning fluid vessel 5A, the CPU 80 stops the driving of the pump 78, and closes, using the solenoid 77, the valve of the inflow hose connected to the inflow port 520. In this way, the CPU 80 stops the supply of the cleaning fluid to the cleaning fluid vessel 5A. The CPU 80 ends the periodic processing. By periodically performing the periodic processing, the cleaning fluid is periodically supplied to the cleaning fluid vessel 5A.

Main Processing

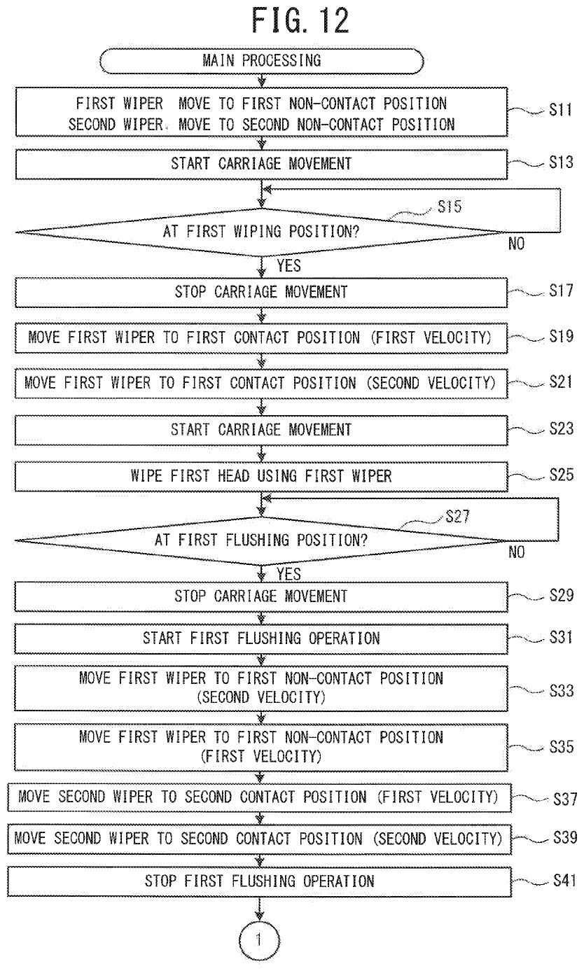

Main processing performed by the CPU 80 of the printer 1 will be described with reference to FIG. 12 to FIG. 20. When a command to perform a maintenance function of the printer 1 or a print command is input via the operation buttons 15B, or when a predetermined timing at which the execution of the maintenance function is programmed to be activated is reached, the main processing is started by the CPU 80 reading out and executing the control program stored in the ROM 81. Note that, at the start of the main processing, it is assumed that a state is obtained, by performing the periodic processing (refer to FIG. 11), in which the cleaning fluid is held in the cleaning fluid vessel 5A. Note also that, when the periodic processing and the main processing are performed at the same time, the CPU 80 prioritizes performing the main processing. Further, it is assumed that the carriage 30 is at the left end reference position (refer to FIG. 14).

In a similar manner to step S81 of the periodic processing, the CPU 80 drives the first motor 611A and moves the first wiper 60A to the first non-contact position. The CPU 80 drives the second motor 611B and moves the second wiper 60B to the second non-contact position (step S11). The CPU 80 drives the main scanning drive portion 83B and starts to move the carriage 30 at the reference position toward the right (an arrow Y13 illustrated in FIG. 14) (step S13). In this way, the carriage 30 moves to the right toward the first wiper 60A and the second wiper 60B of the cleaning assembly 5. Hereinafter, of both directions of the main scanning direction, the direction of the movement of the carriage 30 from the reference position (to the right) is referred to as downstream and the direction opposite to downstream (to the left) is referred to as upstream.

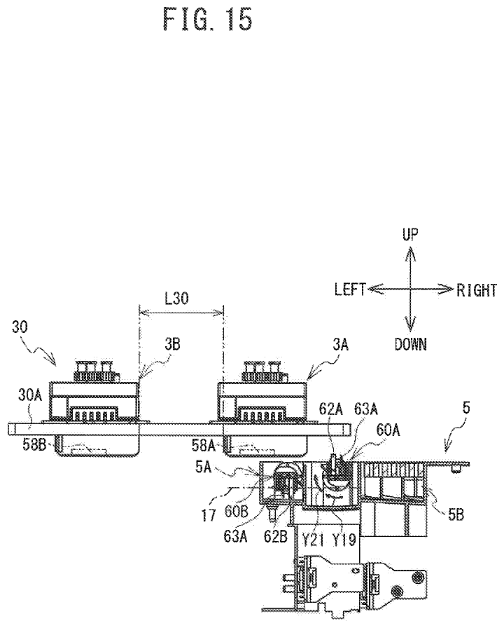

The CPU 80 calculates a movement distance that the carriage 30 has moved from the reference position, on the basis of a number of pulses of a pulse signal output for rotating the main scanning motor 831B of the main scanning drive portion 83B. On the basis of the calculated movement distance, the CPU 80 determines whether the carriage 30 has moved to a first wiping position (refer to FIG. 15) (step S15). As illustrated in FIG. 15, the first wiping position is defined as a position of the carriage 30 when the discharge portion 58A of the first head 3A is disposed upstream of the first wiper 60A in the main scanning direction, and the position of the downstream end of the discharge portion 58A is aligned with the position of the upstream end of the second wiper 60B in the main scanning direction.

As illustrated in FIG. 12, when it is determined that the carriage 30 has not moved to the first wiping position (no at step S15), the CPU 80 returns the processing to step S15. When it is determined that the carriage 30 has moved to the first wiping position (yes at step S15), the CPU 80 drives the main scanning drive portion 83B and stops the movement of the carriage 30 started by the processing at step S13 (step S17).

The CPU 80 controls the first power portion 61A, by driving the first motor 611A, and moves the first wiper 60A that is at the first non-contact position to the first contact position (step S19, step S21). Note that the second wiper 60B is held as it is at the second non-contact position. At this time, the CPU 80 identifies the position of the first wiper 60A on the basis of the number of pulses of a pulse signal output for rotating the first motor 611A. As illustrated in FIG. 15, during a period until the first wiper 60A that is moving upward from the first non-contact position passes through the reference fluid surface 17, the CPU 80 controls a rotation velocity of the first motor 611A such that a movement velocity of the first wiper 60A is a first velocity (step S19). After the first wiper 60A has passed through the reference fluid surface 17, and during a period until the first wiper 60A that is moving further upward reaches the first contact position, the CPU 80 controls the rotation velocity of the first motor 611A such that the movement velocity of the first wiper 60A is a second velocity that is faster than the first velocity (step S21). As illustrated in FIG. 15, a direction of movement of the first wiper 60A when moving at the first velocity is illustrated by an arrow Y19. A direction of movement of the first wiper 60A when moving at the second velocity is illustrated by an arrow Y21. As a result of the control at step S19 and step S21, the movement velocity of the first wiper 60A becomes faster (the second velocity) when moving in a state of not being in contact with the cleaning fluid than the movement velocity (the first velocity) when moving in a state of being in contact with the cleaning fluid. After moving the first wiper 60A to the first contact position, the CPU 80 stops the driving of the first motor 611A and maintains the first wiper 60A at the first contact position.

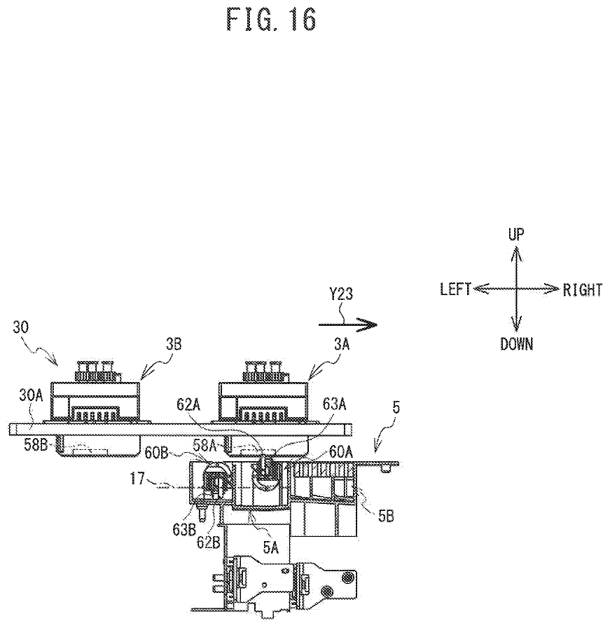

As illustrated in FIG. 12, the CPU 80 controls the main scanning drive portion 83B and starts the downstream movement of the carriage 30 that is at the first wiping position (an arrow Y23 illustrated in FIG. 16) (step S23). As a result, the CPU 80 performs processing causing the first wiper 60A to come into contact with the discharge portion 58A of the first head 3A and wipe the first head 3A (step S25). As illustrated in FIG. 16, in the course of the movement of the carriage 30, the discharge portion 58A of the first head 3A passes over the first wiper 60A that is at the first contact position. The first wiper 60A comes into contact with the discharge portion 58A of the first head 3A in the order of the first foam wiper 62A and the first rubber wiper 63A.

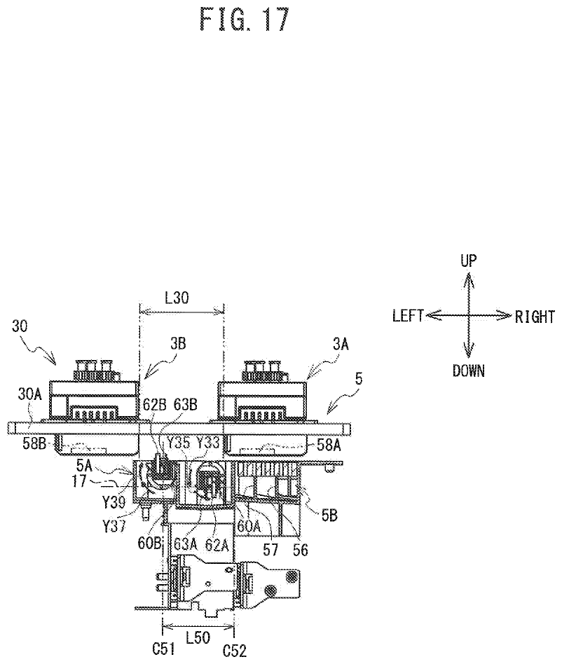

The CPU 80 calculates a movement distance that the carriage 30 has moved from the first wiping position, on the basis of the number of pulses of the pulse signal output for rotating the main scanning motor 831B of the main scanning drive portion 83B. As illustrated in FIG. 12, on the basis of the calculated movement distance, the CPU 80 determines whether the carriage 30 has moved to a first flushing position (step S27). As illustrated in FIG. 17, the first flushing position is defined as a position of the carriage 30 when the discharge portion 58A of the first head 3A is positioned above the flushing box 5B.

As illustrated in FIG. 12, when it is determined that the carriage 30 has not moved to the first flushing position (no at step S27), the CPU 80 returns the processing to step S27. When it is determined that the carriage 30 has moved to the first flushing position (yes at step S27), the CPU 80 controls the main scanning drive portion 83B and stops the movement of the carriage 30 started by the processing at step S23 (step S29). Note that, as illustrated in FIG. 17, the interval L30 between the first head 3A and the second head 3B in the main scanning direction is greater than the interval L50 between the second wiper 60B and the flushing box 5B in the main scanning direction. Thus, in the state in which the carriage 30 is disposed at the first flushing position, the discharge portion 58B of the second head 3B is disposed upstream of the second wiper 60B in the main scanning direction.

As illustrated in FIG. 12, the CPU 80 controls the head drive portion 83A and drives the piezoelectric element provided in the first head 3A, and starts the discharge of the ink toward the flushing box 5B from the discharge portion 58A of the first head 3A (step S31). Hereinafter, this operation is referred to as a first flushing operation.

While the first flushing operation is being performed, the CPU 80 controls the first power portion 61A by driving the first motor 611A, and moves the first wiper 60A that is at the first contact position to the first non-contact position (step S33, step S35). At this time, the CPU 80 identifies the position of the first wiper 60A on the basis of the number of pulses of the pulse signal output for rotating the first motor 611A. On the basis of the identified position of the first wiper 60A, the CPU 80 identifies a period over which the first wiper 60A moves downward from the first contact position until immediately before the first wiper 60A passes through the reference fluid surface 17, and controls the rotation velocity of the first motor 611A such that the movement velocity of the first wiper 60A during this period is the second velocity (step S33). The CPU 80 controls the rotation velocity of the first motor 611A such that the movement velocity of the first wiper 60A is the first velocity from when the first wiper 60A moves further downward and passes through the reference fluid surface 17 to when the first wiper 60A subsequently reaches the first non-contact position (step S35). As illustrated in FIG. 17, a direction of movement of the first wiper 60A when moving at the second velocity at step S33 is illustrated by an arrow Y33 illustrated in FIG. 17, and a direction of movement of the first wiper 60A at step S35 when moving at the first velocity is illustrated by an arrow Y35. As a result of the control at step S33 and step S35, the movement velocity of the first wiper 60A becomes slower (the first velocity) when moving while in contact with the cleaning fluid than the movement velocity (the second velocity) when moving in a state of not being in contact with the cleaning fluid. After moving the first wiper 60A to the first non-contact position, the CPU 80 stops the driving of the first motor 611A and maintains the first wiper 60A at the first non-contact position.

As illustrated in FIG. 12, next, the CPU 80 controls the second power portion 61B by driving the second motor 611B, and moves the second wiper 60B that is at the second non-contact position to the second contact position (step S37, step S39). At this time, the CPU 80 identifies the position of the second wiper 60B on the basis of the number of pulses of a pulse signal output for rotating the second motor 611B. On the basis of the identified position of the second wiper 60B, the CPU 80 identifies a period until the second wiper 60B that is moving upward from the second non-contact position passes through the reference fluid surface 17, and controls a rotation velocity of the second motor 611B such that a movement velocity of the second wiper 60B during this period is the first velocity (step S37). After the second wiper 60B has passed through the reference fluid surface 17, and during a period until the second wiper 60B that is moving further upward reaches the second contact position, the CPU 80 controls the rotation velocity of the second motor 611B such that the movement velocity of the second wiper 60B is the second velocity (step S39). As illustrated in FIG. 17, a direction of movement of the second wiper 60B when moving at the first velocity at step S37 is illustrated by an arrow Y37. A direction of movement of the second wiper 60B when moving at the second velocity at step S39 is illustrated by an arrow Y39. As a result of the control at step S37 and step S39, the movement velocity (the second velocity) of the second wiper 60B becomes faster when moving in a state of not being in contact with the cleaning fluid than the movement velocity (the first velocity) when moving while being in contact with the cleaning fluid. After moving the second wiper 60B to the second contact position, the CPU 80 stops the driving of the second motor 611B and maintains the second wiper 60B at the second contact position.

As illustrated in FIG. 12, after moving the second wiper 60B to the second contact position, the CPU 80 controls the head drive portion 83A and stops the driving of the piezoelectric element provided in the first head 3A, and ends the first flushing operation (step S41).

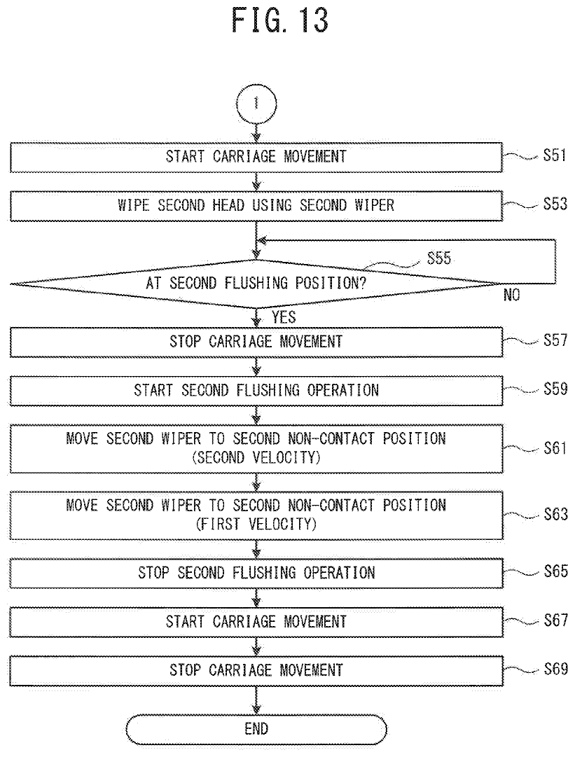

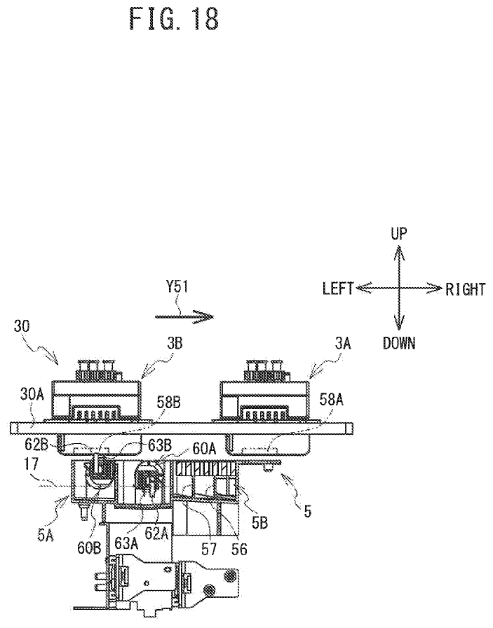

As illustrated in FIG. 13, after stopping the first flushing operation, the CPU 80 controls the main scanning drive portion 83B and starts the downstream movement of the carriage 30 that is at the first flushing position (an arrow Y51 illustrated in FIG. 18) (step S51). As a result, the CPU 80 performs processing causing the second wiper 60B to come into contact with the discharge portion 58B of the second head 3B and wipe the second head 3B (step S53). As illustrated in FIG. 18, in the course of the movement of the carriage 30, the discharge portion 58B of the second head 3B passes over the second wiper 60B that is at the second contact position. The second wiper 60B comes into contact with the discharge portion 58B of the second head 3B in the order of the second foam wiper 62B and the second rubber wiper 63B.

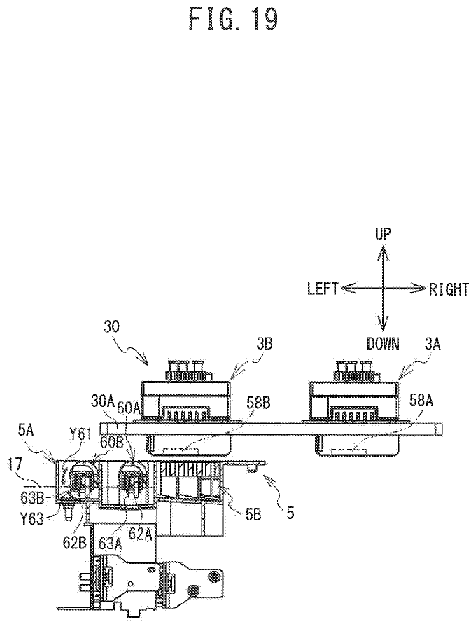

The CPU 80 calculates a movement distance that the carriage 30 has moved from the first flushing position, on the basis of the number of pulses of the pulse signal output for rotating the main scanning motor 831B of the main scanning drive portion 83B. As illustrated in FIG. 13, on the basis of the calculated movement distance, the CPU 80 determines whether the carriage 30 has moved to a second flushing position (step S55). As illustrated in FIG. 19, the second flushing position is defined as a position of the carriage 30 when the discharge portion 58B of the second head 3B is positioned above the flushing box 5B.

As illustrated in FIG. 13, when it is determined that the carriage 30 has not moved to the second flushing position (no at step S55), the CPU 80 returns the processing to step S55. When it is determined that the carriage 30 has moved to the second flushing position, (yes at step S55), the CPU 80 controls the main scanning drive portion 83B and stops the movement of the carriage 30 started by the processing at step S51 (step S57).

The CPU 80 controls the head drive portion 83A and drives the piezoelectric element provided in the second head 3B, and starts the discharge of the ink toward the flushing box 5B from the discharge portion 58B of the second head 3B (step S59). Hereinafter, this operation is referred to as a second flushing operation.

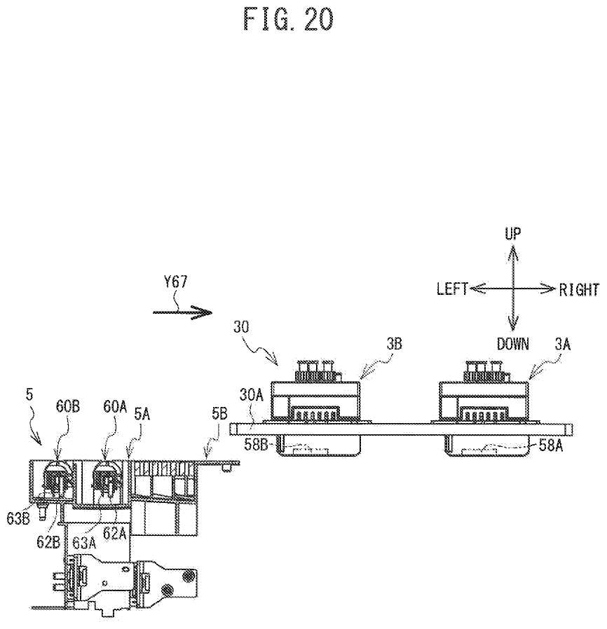

While the second flushing operation is being performed, the CPU 80 controls the second power portion 61B by driving the second motor 611B, and moves the second wiper 60B that is at the second contact position to the second non-contact position (step S61, step S63). At this time, the CPU 80 identifies the position of the second wiper 60B on the basis of the number of pulses of the pulse signal output for rotating the second motor 611B. On the basis of the identified position of the second wiper 60B, the CPU 80 identifies a period over which the second wiper 60B moves downward from the second contact position until immediately before the second wiper 60B passes through the reference fluid surface 17, and controls the rotation velocity of the second motor 611B such that the movement velocity of the second wiper 60B during this period is the second velocity (step S61). The CPU 80 controls the rotation velocity of the second motor 611B such that the movement velocity of the second wiper 60B is the first velocity from when the second wiper 60B moves further downward and passes through the reference fluid surface 17 to when the second wiper 60B subsequently reaches the second non-contact position (step S63). As illustrated in FIG. 20, a direction of movement of the second wiper 60B when moving at the second velocity is illustrated by an arrow Y61, and a direction of movement of the second wiper 60B when moving at the first velocity is illustrated by an arrow Y63. As a result of the control at step S61 and step S63, the movement velocity (the first velocity) of the second wiper 60B becomes slower when moving while in contact with the cleaning fluid than the movement velocity (the second velocity) when moving in a state of not being in contact with the cleaning fluid. After moving the second wiper 60B to the second non-contact position, the CPU 80 stops the driving of the second motor 611B and maintains the second wiper 60B at the second non-contact position (refer to FIG. 19).

As illustrated in FIG. 13, after moving the second wiper 60B to the second non-contact position, the CPU 80 controls the head drive portion 83A and stops the driving of the piezoelectric element provided in the second head 3B, and ends the second flushing operation (step S65). The CPU 80 starts the downstream movement of the carriage 30 that is at the second flushing position (an arrow Y67 illustrated in FIG. 20) (step S67). When the carriage 30 has moved to a downstream end of the movement path or to a predetermined position, the CPU 80 controls the main scanning drive portion 83B, and stops the movement of the carriage 30 started by the processing at step S67 (step S69). The CPU 80 ends the main processing. After the end of the main processing, predetermined processing is performed, such as performing the print processing, performing capping processing using the cap mechanism 40, or the like.

### Operations and Effects of Present Embodiment

In the printer 1, the cleaning fluid that has flowed into the cleaning fluid vessel 5A via the inflow port 520 flows into the flushing box 5B via the first communicating portions 541 to 543. The printer 1 can assist the discharge of the ink accumulated inside the flushing box 5B using the cleaning fluid that has flowed from the cleaning fluid vessel 5A. Thus, the printer 1 can reduce the possibility of the ink that has accumulated inside the flushing box 5B becoming more viscous and solidifying, and can reduce the possibility of the waste liquid not being discharged from the flushing box 5B.

The first communicating portions 541 to 543 are provided at the first side wall 54R provided between the cleaning fluid vessel 5A and the flushing box 5B in the left-right direction. Compared to a case in which the cleaning fluid vessel 5A and the flushing box 5B are separately provided and are communicated with each other by a first communicating portion provided therebetween, the size in the left-right direction of the cleaning fluid vessel 5A and the flushing box 5B can be reduced.

The first communicating portions 541 to 543 are portions cut downward from the upper end of the first side wall 54R, and at least some of the first communicating portions 541 to 543 are lower, in the up-down direction, than the upper ends of the first peripheral walls 51L, 51F, 51S, 52L, 52F, 52S, and 52R of the cleaning fluid vessel 5A. Thus, the cleaning fluid stored in the cleaning fluid vessel 5A does not become higher than the height of the upper ends of the first peripheral walls 51L, 51F, 51S, 52L, 52F, 52S, and 52R, and can smoothly move to the flushing box 5B. Further, it is possible to inhibit the cleaning fluid stored in the cleaning fluid vessel 5A from flowing out to portions other than the cleaning fluid vessel 5A and the flushing box 5B.

In the printer 1, the inclined section 531 is formed between the first communicating portions 541 to 543 and the waste liquid port 530. The inclined section 531 causes the cleaning fluid that has flowed into the flushing box 5B via the first communicating portions 541 to 543 to flow toward the waste liquid port 530 along the inclined section 531. The cleaning fluid at that time can cause the ink that has attached to the inclined section 531 to flow toward the waste liquid port 530. Thus, the printer 1 can reduce the possibility of the ink that has attached to the inclined section 531 becoming more viscous and solidifying.

Inside the flushing box 5B, the printer 1 can cause the cleaning fluid to flow along the flow paths 54A to 54C that are defined by the flow path walls 56 and 57. Thus, the printer 1 can guide the cleaning fluid and cause the cleaning fluid to flow, for example, not only in the region of the second bottom wall 53B in close proximity to the cleaning fluid vessel 5A, but also in regions of the second bottom wall 53B separated from the cleaning fluid vessel 5A. In other words, since the printer 1 can guide the cleaning fluid using the flow paths 54A to 54C in regions of the second bottom wall 53B in which it is difficult for the cleaning fluid to flow in a state where the flow path walls 56 and 57 are not present, the printer 1 can efficiently assist the discharge of the ink over a wide region of the second bottom wall 53B.

The printer 1 is provided with the plurality of first communicating portions 541 to 543. A number of locations increases through which the cleaning fluid can flow into the flushing box 5B, compared to when there is the single first communicating portion, and the printer 1 can efficiently assist the discharge of the ink over the wide region of the second bottom wall 53B.

The flow path walls 56 and 57 of the flushing box 5B define the flow paths 54A to 54C corresponding to each of the first communicating portions 541 to 543. In this case, the printer 1 can cause the cleaning fluid to flow with respect to each of the flow paths 54A to 54C. Thus, the printer 1 can more effectively assist the discharge of the ink from the flushing box 5B.

In the first bottom walls 51B and 52B, the position 54P below the first communicating portion 542 is lower than the position 52P at which the inflow port 520 is formed. In other words, in the first bottom walls 51B and 52B, a height difference is formed between the position 52P at which the inflow port 520 is formed and the position 54P below the first communicating portion 542, such that the point 54P is lower. As a result of this height difference, it is possible for the cleaning fluid that has flowed into the cleaning fluid vessel 5A from the inflow port 520 to flow into the flushing box 5B also, while a predetermined amount of the cleaning fluid is stored in the cleaning fluid vessel 5A.

The discharge port 510 is provided at a position overlapping with the first communicating portion 542 of the first bottom wall 51B, in the front-rear direction. In this case, the printer 1 can use the flow of the cleaning fluid toward the discharge port 510 from the inflow port 520 in the cleaning fluid vessel 5A, and can cause the cleaning fluid to flow from the cleaning fluid vessel 5A to the flushing box 5B via the first communicating portions 541 to 543.

The wipers 60 are provided to be configured to rotate in the cleaning fluid vessel 5A, and at least a part thereof can move to be lower than the first bottom portions 541B, 542B, and 543B that are the lower ends of the first communicating portions 541 to 543. Thus, when the wipers 60 are disposed at the non-contact positions, the wipers 60 are positioned lower than the reference fluid surface 17, and can come into contact with the cleaning fluid stored in the cleaning fluid vessel 5A. Thus, the printer 1 can clean the wipers 60 using the cleaning fluid, by moving the wipers 60 to the non-contact positions. The wipers 60 may be configured such that the whole of the wipers 60 can move lower than the first bottom portions 541B, 542B, and 543B, or may be configured such that at least a part of the wipers 60 can move lower than the first bottom portions 541B, 542B, and 543B.

The printer 1 cleans the first wiper 60A using the cleaning fluid in the first section 511 of the cleaning fluid vessel 5A, and cleans the second wiper 60B using the cleaning fluid in the second section 521 of the cleaning fluid vessel 5A. The second communicating portion 551 of the second side wall 55R moves the cleaning fluid between the first section 511 and the second section 521. Here, the second bottom portion 551B of the second communicating portion 551 is disposed at a position lower than the first bottom portions 541B to 543B of the first communicating portions 541 to 543. Thus, the cleaning fluid of the cleaning fluid vessel 5A can be suppressed from flowing into the flushing box 5B via the first communicating portions 541 to 543 before being used to clean the wipers 60 in the first section 511 and the second section 521. Thus, the printer 1 can hold the cleaning fluid in the cleaning fluid vessel 5A and thus, the printer 1 can clean the wipers 60 using a sufficient amount of the cleaning fluid.

When the positions of the first communicating portions 541 to 543 and the second communicating portion 551 are close together in the front-rear direction, the movement of the cleaning fluid inside the cleaning fluid vessel 5A is suppressed, and there is a possibility that old cleaning fluid may partly remain in the cleaning fluid vessel 5A. In contrast to this, by separating the first communicating portions 541 to 543 and the second communicating portion 551 in the front-rear direction, the printer 1 can encourage the movement of the cleaning fluid inside the cleaning fluid vessel 5A. Thus, the printer 1 can reduce the possibility of the old cleaning fluid partly remaining in the cleaning fluid vessel 5A. In this case, the printer 1 can effectively clean the wipers 60 using the new cleaning fluid.

The printer 1 periodically discharges the cleaning fluid from the cleaning fluid vessel 5A by periodically performing the periodic processing (step S93), and subsequently periodically supplies the cleaning fluid to the cleaning fluid vessel 5A (step S95). Thus, the printer 1 can periodically assist the discharge of the ink that has accumulated in the flushing box 5B, using the cleaning fluid periodically supplied to the cleaning fluid vessel 5A. Further, the printer 1 can periodically discharge, from the discharge port 510, the cleaning fluid that has been contaminated by the cleaning of the wipers 60 by the main processing.

In the periodic processing, the printer 1 moves the wipers 60 in the cleaning fluid (step S87, step S89), and cleans the wipers 60. Thus, the printer 1 can effectively clean the wipers 60 using the cleaning fluid, compared to a case in which the wipers 60 are in a static state inside the cleaning fluid. Further, the printer 1 can clean the wipers 60 using the cleaning fluid, before the ink attached to the wipers 60 dries out, by rotating the wipers 60 in the cleaning fluid in the periodic processing that is periodically performed. Note that, at step S87, the wipers 60 may be disposed in the cleaning fluid, and subsequently, the CPU 80 may move the wipers 60 through the air. After that, at step S88, the CPU 80 may dispose the wipers 60 in the cleaning fluid. Further, at step S87 and step S89, it is sufficient that at least part of the wipers 60 be in contact with the cleaning fluid.

When, in the movement of the wipers 60, the wipers 60 pass through the reference fluid surface 17, the printer 1 moves the wipers 60 at the first velocity (step S19, step S35, step S37, step S63). On the other hand, in the movement of the wipers 60, when the wipers 60 do not pass through the reference fluid surface 17, the printer 1 causes the wipers 60 to move at the second velocity that is faster than the first velocity (step S21, step S33, step S39, step S61). In this case, the printer 1 can suppress the cleaning fluid from being dispersed to the outside of the cleaning fluid vessel 5A when the wipers 60 pass through the fluid surface of the cleaning fluid, by causing the movement velocity of the wipers 60 to be relatively slow. Thus, the printer 1 can reduce the possibility of the surroundings of the cleaning assembly 5 becoming contaminated by the cleaning fluid that has been dispersed from the cleaning fluid vessel 5A. Note that it is sufficient that the wipers 60 move at the first velocity when the wipers 60 pass through the reference fluid surface 17, and during the period from the non-contact positions to passing through the reference fluid surface 17, the wipers 60 need not necessarily always move at the first velocity. Similarly, the wipers 60 may move at the second velocity at a given time point, during the period from passing through the reference fluid surface 17 to moving as far as the contact positions.

### Modified Examples

The present disclosure is not limited to the above-described embodiment and various modifications are possible. The cleaning fluid vessel 5A and the flushing box 5B include the shared side wall, namely, the first side wall 54R, but the cleaning fluid vessel 5A and the flushing box 5B need not necessarily include the shared side wall, and may be separately provided. In this case, a first communicating portion formed of a tube, a wall portion, or the like may be provided that causes the cleaning fluid vessel 5A and the flushing box 5B to be communicated with each other.

The first communicating portions 541 to 543 are not limited to the cut out shape that is recessed downward in the first side wall 54R, and through holes may be provided in the first side wall 54R. In this case, all the portions of the through holes may be positioned lower than the upper ends of each of the first peripheral walls 51L, 51F, 51S, 52L, 52F, 52S, and 52R.

The upper end of the first side wall 54R may be positioned higher than the upper ends of each of the first peripheral walls 51L, 51F, 51S, 52L, 52F, 52S, and 52R. In this case, part of the upper ends of each of the first communicating portions 541 to 543 may be positioned higher than the upper ends of each of the first peripheral walls 51L, 51F, 51S, 52L, 52F, 52S, and 52R. At least some of the first communicating portions 541 to 543 that are provided as the cut out portions or the through holes, or at least some of the first communicating portions that cause the separately provided cleaning fluid vessel 5A and flushing box 5B to be communicated with each other are preferably positioned lower than the upper ends of each of the first peripheral walls 51L, 51F, 51S, 52L, 52F, 52S, and 52R, from the viewpoints of the smooth flowing of the cleaning fluid, and reducing leaks of the cleaning fluid from the cleaning fluid vessel 5A and the flushing box 5B.

The inclined section 531 of the flushing box 5B is not limited to the case of being formed across the whole area between the first communicating portions 541 to 543 of the first side wall 54R and the waste liquid port 530, of the second bottom wall 53B. For example, the inclined section 531 may be formed only at part of the second bottom wall 53B, of the section between the first communicating portions 541 to 543 of the first side wall 54R and the waste liquid port 530, and the rest of the second bottom wall 538 may be horizontal. Steps that gradually become lower from the first communicating portions 541 to 543 toward the waste liquid port 530 may be formed in place of the inclined section 531.

The flow paths 54A to 54C formed in the flushing box 5B are not limited to the case of being formed by the flow path walls 56 and 57. For example, the flow paths 54A to 54C may be formed by grooves formed in the second bottom wall 53B. The waste liquid port 530 may be formed in a corner diagonally to the right and front of the second bottom wall 53B. In this case, the flow paths 54A to 54C may extend diagonally to the right and the front toward the waste liquid port 530 from the first communicating portions 541 to 543. Further, the flow paths 54A to 54C need not necessarily extend from the first communicating portions 541 to 543. The number of flow paths formed in the flushing box 5B may be any one of one, two, or four or more. The number of the flow paths need not necessarily correspond to the number of the first communicating portions 541 to 543.

Heights of the position 52P at which the inflow port 520 is formed, of the first bottom wall 51B, and the position 54P that is lower than the first bottom portion 542B of the first communicating portion 542, of the first bottom wall 52B may be aligned, or the position 54P may be higher than the position 52P. In the above description, the inclination that becomes lower from the rear to the front is formed at the first bottom wall 52B, and the inclination that becomes lower from the portion at which the discharge port 510 is formed is formed at the first bottom wall 51B. In contrast to this, the inclination may be provided at only one of the first bottom walls 51B and 52B, and the other may be horizontal. The discharge port 510 may be provided over a wide range of the first bottom wall 51B, across a portion overlapping with the first communicating portions 541 to 543 in the main scanning direction. The discharge port 510 may be provided at the position 54P below the first bottom portion 542B of the first communicating portion 542. A plurality of the inflow ports 520 may be provided in the first bottom wall 52B. A plurality of the discharge ports 510 may be provided in the first bottom wall 51B.

With respect to the wipers 60 that are disposed at the non-contact positions, only a part of the tip ends may be disposed lower than the reference fluid surface 17. On the other hand, with respect to the wipers 60 that are disposed at the non-contact positions, the whole of the wipers 60, including portions supported by the base portions 65A and 65B may be positioned lower than the reference fluid surface 17. Heights of the first bottom portions 541B to 543B of the first communicating portions 541 to 543, and the second bottom portion 551B of the second communicating portion 551 may be aligned, or the second bottom portion 551B may be higher than the first bottom portions 541B to 543B. The second communicating portion 551 is not limited to being the cut out that is recessed downward in the second side wall 55R, and may be a through hole provided in the second side wall 55R.

The number of the first communicating portions may be one, two, or four or more. The number of the second communicating portions may be two or more. The first communicating portions may be provided in the vicinity of the front end of the first side wall 54R. When the plurality of first communicating portions are provided, the lower end of the first communicating portion furthest to the front may be positioned lower than the first support portion 513 that is the recessed portion recessed downward. In this way, when the front of the cleaning fluid vessel 5A is inclined downward, the cleaning fluid first flows into the flushing box 5B from the first communicating portion that is disposed furthest to the front, and thus, it is possible to reduce the possibility of the cleaning fluid leaking from the first support portion 513. Similarly, when the plurality of first communicating portions are provided, the lower end of the first communicating portion furthest to the rear may be positioned lower than the first support portion 514 that is the recessed portion recessed downward.

The second communicating portion may be provided in the vicinity of the rear end of the second side wall 55R. The first communicating portion and the second communicating portion may be disposed at the same position in the front-rear direction.

The specific example of the period (24 hours) at which the periodic processing is performed is an example, and the periodic processing may be performed at another period. The period at which the periodic processing is performed may be switched depending on a frequency of performing the flushing operation. In the periodic processing, the specific example of the number of times the wipers 60 are caused to reciprocate (ten times) is an example, and the number of times the wipers 60 are caused to reciprocate may be another value. The number of times the wipers 60 are caused to reciprocate may be switched depending on a degree of contamination of the wipers 60. For example, it is assumed that the degree of contamination of the wipers 60 will increase in accordance with the number of times the main processing is performed, and thus, the printer 1 may switch the number of times the wipers 60 are caused to reciprocate in accordance with the number of times the main processing is performed. The supply of the cleaning fluid to the cleaning fluid vessel 5A (step S95), and the cleaning of the wipers 60 by causing the wipers 60 to reciprocate in the cleaning fluid (step S87, step S89) may be performed by separate processing and need not necessarily be performed at the same time. The discharge port 510 need not necessarily be provided in the first bottom wall 51B. In this case, the cleaning fluid that has flowed into the cleaning fluid vessel 5A via the inflow port 520 may all be discharged via the waste liquid port 530 of the flushing box 5B. In this way, at step S93, the CPU 80 may discharge the cleaning fluid stored in the storage space 512 of the cleaning fluid vessel 5A from the waste liquid port 530.

The printer 1 may cause the movement velocity of the wipers 60 to be the first velocity only when the wipers 60 are passing through the reference fluid surface 17, and at other times, may cause the movement velocity to be the second velocity, regardless of whether the wipers 60 are moving while in contact with the cleaning fluid. In a specific example, the printer 1 may cause the movement velocity of the wipers 60 to be the second velocity: a) during a period in which the wipers 60 move from the non-contact positions to immediately before passing through the reference fluid surface 17, in the course of moving from the non-contact positions toward the contact positions; b) during a period in which the wipers 60 move from immediately after passing through the reference fluid surface 17 to the contact positions, in the course of moving from the non-contact positions to the contact positions; c) during a period in which the wipers 60 move from the contact positions to immediately before passing through the reference fluid surface 17, in the course of moving from the contact positions to the non-contact positions; and d) during a period in which the wipers 60 move from immediately after passing through the reference fluid surface 17 to the non-contact positions, in the course of moving from the contact positions to the non-contact positions.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A printer comprising:
a discharge portion configured to discharge ink;
a cleaning fluid vessel including an inflow port, and a first peripheral wall and a first bottom wall extending in a first direction orthogonal to an up-down direction, or in a second direction orthogonal to the up-down direction and the first direction and defining a storage space configured to store a cleaning fluid flowing in from the inflow port;
a flushing box, connected to the cleaning fluid vessel on one side in the first direction, configured to receive the ink discharged from the discharge portion; and
a first communicating portion configured to communicate the cleaning fluid vessel and the flushing box.

2. The printer according to claim 1, wherein
the first communicating portion is provided at a first side wall provided between the cleaning fluid vessel and the flushing box in the first direction.

3. The printer according to claim 1, wherein
at least a part of the first communicating portion is lower, in the up-down direction, than an upper end of the first peripheral wall of the cleaning fluid vessel.

4. The printer according to claim 1, wherein
the flushing box includes a second bottom wall, and
the second bottom wall includes
a waste liquid port separated from the first communicating portion in the second direction, and
an inclined section positioned between the first communicating portion and the waste liquid port in the second direction, the inclined section becoming lower from the first communicating portion toward the waste liquid port.

5. The printer according to claim 4, wherein
the flushing box includes a flow path wall extending upward from the second bottom wall and defining a flow path toward the waste liquid port.

6. The printer according to claim 1, wherein
a plurality of the first communicating portions are provided to be mutually separated in the second direction.

7. The printer according to claim 2, wherein
the inflow port is formed in the first bottom wall,
the first side wall extends upward from the first bottom wall, and
at the first bottom wall, a position below the first communicating portion is lower than a position at which the inflow port is formed.

8. The printer according to claim 1, wherein
a discharge port is formed at a position in the first bottom wall, the position overlapping the first communicating portion and the first bottom wall in the second direction.

9. The printer according to claim 1, further comprising:
a wiper rotatably provided in the cleaning fluid vessel, at least a part of the wiper being configured to move lower than a lower end of the first communicating portion.

10. The printer according to claim 9, wherein
the wiper includes a first wiper and a second wiper,
the cleaning fluid vessel includes
a first section configured to house the first wiper and a second section configured to house the second wiper, the second section being positioned opposite to the flushing box with respect to the first section in the first direction,
a second side wall provided between the first section and the second section, and
a second communicating portion provided at the second side wall, the second communicating portion configured to communicate the first section and the second section, and
a lower end of the second communicating portion is lower than a lower end of the first communicating portion.

11. The printer according to claim 10, wherein
the second communicating portion is separated from the first communicating portion in the second direction.

12. The printer according to claim 1, further comprising:
a supply mechanism configured to supply the cleaning fluid to the cleaning fluid vessel via the inflow port; and
a processor; and
a memory storing computer-readable instructions that, when executed by the processor, cause the processor to perform a process comprising:
performing control of controlling the supply mechanism and causes the supply mechanism to supply the cleaning fluid to the cleaning fluid vessel.

13. The printer according to claim 12, further comprising:
a drive mechanism configured to rotate a wiper, wherein
the computer-readable instructions stored in the memory further cause the processor to perform a process comprising:
performing control of controlling the drive mechanism and rotating the wiper in a state of the cleaning fluid being held in the cleaning fluid vessel and at least a part of the wiper being in contact with the cleaning fluid.

14. The printer according to claim 13, wherein
the computer-readable instructions stored in the memory further cause the processor to perform a process comprising:
performing control of controlling the drive mechanism and rotating the wiper at a predetermined period.

15. The printer according to claim 13, wherein
the computer-readable instructions stored in the memory further cause the processor to perform a process comprising:
performing control of controlling the drive mechanism and, after starting rotation of the wiper, discharging the cleaning fluid from the cleaning fluid vessel.

16. The printer according to claim 13, wherein
the wiper is configured to rotate between a first position where a tip end is oriented upward and a second position where the tip end is oriented downward, and
the computer-readable instructions stored in the memory further cause the processor to perform a process comprising:
in a state of rotating the wiper from one to the other of the first position and the second position in a state of the cleaning fluid being held in the cleaning fluid vessel, performing control of causing the wiper to move at a first velocity when the wiper passes through a fluid surface of the cleaning fluid, and causing the wiper to move at a second velocity faster than the first velocity when the wiper does not pass through the fluid surface of the cleaning fluid.

17. A cleaning assembly comprising:
a cleaning fluid vessel including an inflow port, and a first peripheral wall and a first bottom wall extending in a first direction orthogonal to an up-down direction, or in a second direction orthogonal to the up-down direction and the first direction and defining a storage space configured to store a cleaning fluid flowing in from the inflow port;
a flushing box, connected to the cleaning fluid vessel on one side in the first direction, configured to receive an ink discharged from a discharge portion configured to discharge the ink; and
a first communicating portion configured to communicate the cleaning fluid vessel and the flushing box.

18. The cleaning assembly according to claim 17, wherein
the first communicating portion is provided at a first side wall provided between the cleaning fluid vessel and the flushing box in the first direction.

19. The cleaning assembly according to claim 17, wherein
at least a part of the first communicating portion is lower, in the up-down direction, than an upper end of the first peripheral wall of the cleaning fluid vessel.

20. The cleaning assembly according to claim 17, wherein
the flushing box includes a second bottom wall, and
the second bottom wall includes
a waste liquid port separated from the first communicating portion in the second direction, and
an inclined section positioned between the first communicating portion and the waste liquid port in the second direction, the inclined section becoming lower from the first communicating portion toward the waste liquid port.

21. The cleaning assembly according to claim 20, wherein
the flushing box includes a flow path wall extending upward from the second bottom wall and defining a flow path toward the waste liquid port.

22. The cleaning assembly according to claim 18, wherein
the first side wall includes a plurality of the first communicating portions mutually separated in the second direction.

23. The cleaning assembly according to claim 18, wherein
the inflow port is formed in the first bottom wall,
the first side wall extends upward from the first bottom wall, and
at the first bottom wall, a position below the first communicating portion is lower than a position at which the inflow port is formed.

24. The cleaning assembly according to claim 17, wherein
of the first bottom wall, a discharge port is formed at a section overlapping the first communicating portion in the second direction.

25. The cleaning assembly according to claim 17, further comprising:
a wiper rotatably provided in the cleaning fluid vessel, at least a part of the wiper being configured to move lower than a lower end of the first communicating portion.

26. The cleaning assembly according to claim 25, wherein
the wiper includes a first wiper and a second wiper,
the cleaning fluid vessel includes
a first section configured to house the first wiper and a second section configured to house the second wiper, the second section being positioned opposite to the flushing box with respect to the first section in the first direction,
a second side wall provided between the first section and the second section, and
a second communicating portion provided at the second side wall, the second communicating portion configured to communicate the first section and the second section, and
a lower end of the second communicating portion is lower than a lower end of the first communicating portion.

27. The cleaning assembly according to claim 26, wherein
the second communicating portion is separated from the first communicating portion in the second direction.
